(19) United States
(12) Patent Application Publication
(10) Pub. No.: US 2008/0049610 A1
(43) Pub. Date: Feb. 28, 2008

(54) ROUTING FAILURE RECOVERY MECHANISM FOR NETWORK SYSTEMS

(76) Inventors: Pinai LINWONG, Yokohama (JP); Kazuhiro Kusama, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/838,555

(22) Filed: Aug. 14, 2007

(30) Foreign Application Priority Data
Aug. 23, 2006 (JP) 2006-226720

(51) Int. Cl. G08C 15/00

(52) U.S. Cl. 370/225

(57) ABSTRACT

A network unit for exchanging control messages with a remote network unit through a communication path to be established in a network. The network unit enables recovery of failures whether they occur in any of one way links, both-way links. The network unit also enables recovery of node failures to occur in a GMPLS network. The network decides whether or not it is possible to bypass all failure-occurred links detected in the communication path by switching the communication path to another by itself. When it is possible, the network unit detects the switching state of a downward segment that can bypass all those failure-occurred links. If the communication path is already switched or being switched in the downward segment, the network unit cancels the switching. If the communication path is not switched nor being switched in the downward segment, the network unit switches the communication path to a bypass route.

### CLAIM OF PRIORITY

The present application claims priority from Japanese application JP 2006-226720 filed on Aug. 23, 2006, the content of which is hereby incorporated by reference into this application.

### FIELD OF THE INVENTION

The present invention relates to a communication path multiple failure recovery system to be used in a communication network for establishing a communication path with use of a signaling protocol.

### BACKGROUND OF THE INVENTION

There are some techniques used for controlling a communication path in a communication network respectively. One of them is, for example, the GMPLS (Generalized Multi-Protocol Label Switching Architecture). The GMPLS technique uses a signaling protocol such as GMPLS generalized RSVP-TE (IETF, RFC3473, L. Berger, et al, “Generalized Multi-Protocol Label Switching (GMPLS) Signaling Resource reservation Protocol-Traffic Engineering (RSVP-TE) (Extensions”), etc. to set a virtual communication path in a communication network configured by network units such as wavelength division multiplexers, time division multiplexers, packet switches, etc.

For example, Louis Berger, et al, GMPLS Based Segment Recovery, IETF Internet-Draft, draft-ietf-ccamp-gmpls-segment-recovery-02.txt discloses a technique for recovering failures in communication path automatically. According to this technique, a standby communication path is prepared in advance in each section of the communication path and it is assumed as a bypass when the communication path is established. Also, if a failure is detected in an interface through which the communication path passes, a failure event is exchanged among network units so that the communication path is switched to a standby communication path that can bypass the failure location, thereby the communication is recovered automatically.

### SUMMARY OF THE INVENTION

According to the technique described in Louis Berger, et al, GMPLS Based Segment Recovery, IETF Internet-Draft, draft-ietf-ccamp-gmpls-segment-recovery-02.txt, if a network unit detects a failure in a communication network, the network unit decides the necessity of switching the current communication path to another according to one failure event. For example, if a network unit detects a downward failure, the network unit switches the communication path at the most upstream side segment that includes the failure detected section. If the network unit detects a failure in the upstream, however, the network unit switches the communication path at the most downstream side segment that includes the failure detected section. If failures occur in a two-way link (both upstream and downstream), the network unit switches the communication path in two different segments according to those upstream and downstream failure events that are assumed as triggers for the path switching. This results in disconnection of the communication and this has been a problem (first problem).

The technique disclosed in Louis Berger, et al, GMPLS Based Segment Recovery, IETF Internet-Draft, draft-ietf-ccamp-gmpls-segment-recovery-02.txt does not have any means for identifying a segment to which each attribute information included in a signaling message corresponds. This is why the technique cannot satisfy both requirements; one of the requirements is to enable attribute information of a plurality of segments to be exchanged among network units and the other requirement is to enable each attribute information to be related to a segment. Consequently, each network unit cannot know the state of each segment in the subject communication path. This has also been a problem (second problem).

Under such circumstances, it is an object of the present invention to provide a network unit as typically to be described below. Concretely, the network unit includes a processor for executing computing operations and a memory used by the processor. The network unit exchanges control messages with other remote network units along a communication path to be established in a network. The network has a bypass route set for each segment that includes one or a plurality of links. The processor, upon detecting a link failure in the communication path, notifies the remote network units of a failure event notifying the link failure and switches the failure detected link to another. The processor, upon receiving the failure event from a remote network unit, switches the link related to the received failure event to another. The processor then adds the ID information of the switched section of the link to the control message and sends the ID information added control message to the remote network unit. The processor also decides whether or not it is possible to bypass all the failure links detected in the communication path if its network unit switches the current communication path to another. If decided to be possible, the processor detects the switching state of a downward segment that can bypass all of the failure links. However, if the communication path is already switched or being switched in the downward segment, the processor cancels the switching. If the communication path is not switched nor being switched in the downstream segment, the processor switches the current communication path to the bypass route.

According to the present invention, therefore, each network unit can know the state of each segment in the communication path and can switch the current communication path to another no matter where the failure occurs in the upward direction or in the downward direction.

### BRIEF DESCRIPTION OF THE DRAWINGS

FIG. 1 is a configuration of a communication network that uses a network unit in a first embodiment of the present invention;

FIG. 2 is a hardware configuration of a GMPLS switch sw_c in the first embodiment of the present invention;

FIG. 3 is a diagram for showing a relationship between a recovery path and a segment in the first embodiment of the present invention;

FIG. 4A is a sequence diagram for showing how a primary path is established in the first embodiment of the present invention;

FIG. 4B is another sequence diagram for showing how a primary path is established in the first embodiment of the present invention (continued);

FIG. 4C is still another sequence diagram for showing how a primary path is established in the first embodiment of the present invention (continued);

FIG. 5 is a sequence diagram for showing how a recovery path is established in the first embodiment of the present invention;

FIG. 6A is a sequence diagram for showing how a path is switched to another in the first embodiment (when failures occur in both upward and downward directions in the links 31 and 32);

FIG. 6B is a sequence diagram for showing how the recovery state of a recovery path is changed to “on” in the first embodiment of the present invention;

FIG. 6C is a sequence diagram for showing how the running state of the primary path of a segment is changed to “idle” in the first embodiment of the present invention;

FIG. 7 is a sequence diagram for showing how a path is switched to another (to cope with a failure detected in the node C) in the first embodiment of the present invention;

FIG. 8 is a software configuration of a GMPLS switch sw_c in the first embodiment of the present invention;

FIG. 9 is a format of GMPLS generalized RSVP-TE messages in the first embodiment of the present invention;

FIG. 10 is a format of GMPLS generalized RSVP-TE PATH messages (part of a message sent from CONT_B to CONT_C) in the first embodiment of the present invention;

FIG. 11 is a format of GMPLS generalized RSVP-TE RESV messages (part of a message sent from CONT_C to CONT_B) in the first embodiment of the present invention;

FIG. 12A is a configuration of a rerouting table of CONT_A assumed after receiving a RESV message in the first embodiment of the present invention;

FIG. 12B is a configuration of a rerouting table of CONT_B assumed after receiving a RESV message in the first embodiment of the present invention;

FIG. 12C is a configuration of a rerouting table of CONT_C assumed after receiving a RESV message in the first embodiment of the present invention;

FIG. 12D is a configuration of a rerouting table of each of control units CONT_D and CONT_C assumed after receiving a RESV message in the first embodiment of the present invention;

FIG. 13A is a configuration of a cross-connect information table of the control unit (CONT_A) assumed after receiving a RESV message in the first embodiment of the present invention;

FIG. 13B is a configuration of a cross-connect information table of the control unit (CONT_B) assumed after receiving a RESV message in the first embodiment of the present invention;

FIG. 13C is a configuration of a cross-connect information table of the control unit (CONT_C) assumed after receiving a RESV message in the first embodiment of the present invention;

FIG. 13D is a configuration of a cross-connect information table of the control unit (CONT_D) assumed after receiving a RESV message in the first embodiment of the present invention;

FIG. 13E is a configuration of a cross-connect information table of the control unit (CONT_E) assumed after receiving a RESV message in the first embodiment of the present invention;

FIG. 14A is a configuration of a session information table of the control unit (CONT_A) assumed after receiving a RESV message in the first embodiment of the present invention;

FIG. 14B is a configuration of a session information table of the control unit (CONT_B) assumed after receiving a RESV message in the first embodiment of the present invention;

FIG. 14C is a configuration of a session information table of the control unit (CONT_C) assumed after receiving a RESV message in the first embodiment of the present invention;

FIG. 14D is a configuration of a session information table of the control unit (CONT_D) assumed after receiving a RESV message in the first embodiment of the present invention;

FIG. 14E is a configuration of a session information table of the control unit (CONT_E) assumed after receiving a RESV message in the first embodiment of the present invention;

FIG. 15 is a configuration of a segment management table in each of the control units (CONT_A to CONT_E) assumed after receiving a RESV message in the first embodiment of the present invention;

FIG. 16 is a configuration of a failure notification address table in each of the control units (CONT_A to CONT_E) assumed after receiving a RESV message in the first embodiment of the present invention;

FIG. 17 is a configuration of a failure status table in each of the control units (CONT_A to CONT_E) assumed after receiving a RESV message in the first embodiment of the present invention;

FIG. 18 is a flowchart of segment registering processings executed upon receiving a PATH message from a PATH message processor at a recovery segment management unit in the first embodiment of the present invention;

FIG. 19 is a flowchart of segment registering processings for a rerouting table upon receiving a RESV message at the recovery segment management unit in the first embodiment of the present invention;

FIG. 20 is a flowchart of registering processings executed by the recovery segment management unit on rerouting conditions that are failures occurred in a self-node control segment and in a downward segment in the first embodiment of the present invention;

FIG. 21 is a flowchart of registering processings executed by the recovery segment management unit to cope with failures occurred in a self-node control segment and in an upward segment that are assumed as rerouting conditions in the first embodiment of the present invention;

FIG. 22 is a flowchart of registering processings executed by the recovery segment management unit to cope with failures occurred in a self-node control segment that is assumed as a rerouting condition in the first embodiment of the present invention;

FIG. 23 is a flowchart of registering processings executed by the recovery segment management unit so as to register a failure notification address to the failure notification address table through a failure notification address information accumulator in the first embodiment of the present invention;

FIG. 24 is a flowchart of rerouting processings executed by the rerouting unit upon receiving a NOTIFY message from the NOTIFY message processor in the first embodiment of the present invention;

FIG. 25 is a flowchart of rerouting processings executed by the rerouting unit in the first embodiment upon receiving a failure notification message from a failure detection unit in the first embodiment of the present invention;

FIG. 26A is a configuration of a cross-connect information table of the control unit CONT_A assumed after switching to a recovery segment in the first embodiment of the present invention;

FIG. 26B is a configuration of a cross-connect information table of the control unit CONT_C assumed after switching to a recovery segment in the first embodiment of the present invention;

FIG. 27 is a configuration of a segment management table in each of the control units CONT_A to CONT_C assumed after switching to a recovery segment in the first embodiment of the present invention;

FIG. 28 is a configuration of a failure status table 1000 in each of the control units CONT_A to CONT_C (assumed after occurrence of failures in bidirectional links 31 and 32) in the first embodiment of the present invention;

FIG. 29 is a configuration of a failure status table 1000 in each of the control units CONT_A to CONT_C (assumed after occurrence of failures in bidirectional links 31 and 32) in the first embodiment of the present invention; and

FIG. 30 is a format of control messages according to a message structuring method in a second embodiment of the present invention.

### DETAILED DESCRIPTION OF THE PREFERRED EMBODIMENTS

At first, the outline of the present invention will be described.

According to the first aspect of the present invention, the network unit includes a means for setting a segment ID in each attribute information included in each signaling protocol message exchanged among network units.

According to the second aspect of the present invention, the network unit includes a means for checking whether or not it is possible to bypass all the detected failure links if its node switches the current communication path to another while only one failure location is detected in the subject communication path or while a plurality of detected link failure locations are adjacent to each another in the communication path.

According to the third aspect of the present invention, the network unit includes a means for controlling so that the network unit does not switch to a recovery path when it is not possible to bypass all the failure links or switches back to the original communication path.

According to the fourth aspect of the present invention, the node of the network unit includes a means to be used as follows: At first, the network unit checks the switching state of a downward segment that can bypass all the failure links when it is possible to bypass all the failure links if its node switches the current communication path to another. Also, if the communication path is already switched or being switched in the downward segment, the network unit node does not switch the path. On the other hand, the node switches the route of the communication path to another if the communication path is not switched nor being switched in the downward segment.

The network unit uses the means according to the fourth aspect of the present invention in any of the following two methods to check the switching state of the downward segment. The first method is to set operation rules commonly among nodes, thereby the network unit can know the switching state of another node indirectly according to a failure event. The second method is to enable each switching event to be exchanged among nodes, thereby the network unit can know the switching state of another segment directly.

Instead of the means according to the fourth aspect of the present invention, which checks the switching state of a segment in the downstream, the network unit may have a fifth means for checking the switching state of a segment in the upstream.

Which of the fourth means and the fifth means should be employed should be decided identically among all the network units in a system.

Providing each network unit with the first means such way enables the network unit to know the state of each segment in the communication path. In addition, providing each network unit with the second, third, and forth means enables the communication path to be switched in the same section regardless of the failure detected direction (upward/downward), thereby it is possible to recover failures in both upward and downward links. Similarly, providing each network unit with the second, third, and fifth means also enables the communication path to be switched in the same section, thereby it is possible to recover the communication from failures to occur in both upward and downward links.

Next, the preferred embodiments of the present invention will be described with reference to the accompanying drawings. In all the drawings, the same reference numerals will be used for the same and similar components and parts, avoiding redundant description.

In the embodiments to be described below, GMPLS (Generalized Multi-Protocol Label Switching) generalized RSVP-TE (Signaling Resource reservation Protocol-Traffic Engineering) created by the Internet international organization IETF (Internet Engineering Task Force) and regulated by the protocol IETF RFC3473 is used as communication path establishing control signals. The present invention can also use another protocol such as the CR-LDP (Constraint-based Routed Label Distribution Protocol) regulated by the protocol IETF RFC3472, the ASON that is the protocol ITU-T G. 7713/Y. 1704 regulated by the ITU-T (International Telecommunication Union-Telecommunication Standardization Sector) that is an electric communication international standardization division.

### First Embodiment

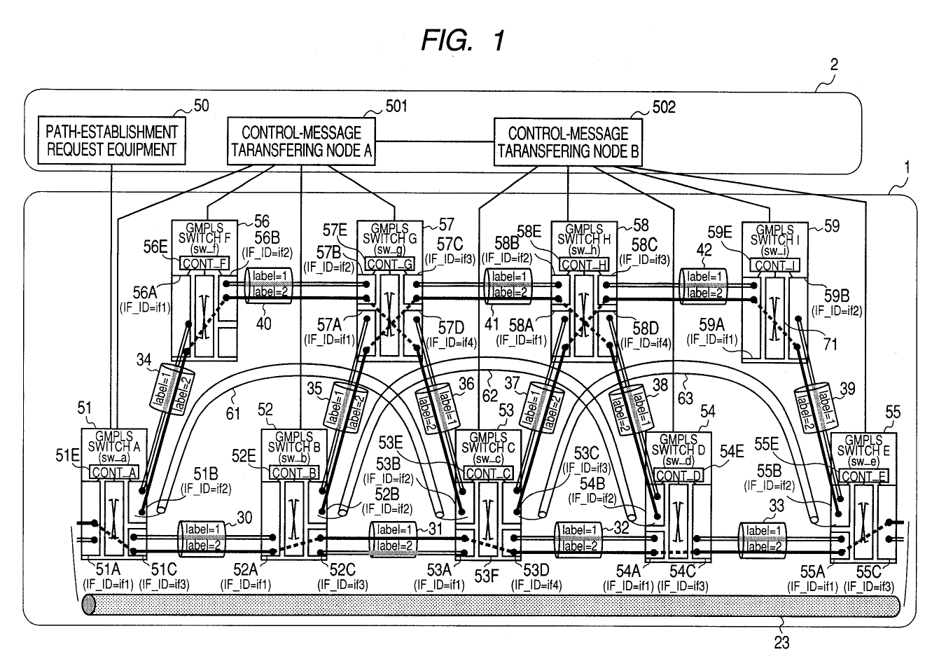

At first, a description will be made for a configuration of a communication network system in a first embodiment of the present invention with reference to FIG. 1.

A network 1 shown in FIG. 1 consists of a plurality of network units 51 to 59 connected to each another through transmission lines 30 to 42. In this first embodiment, the network 1, which consists of 9 network units and 13 transmission lines, may be set freely for the number of network units and the topology. In addition, each transmission line between network units is enabled for bidirectional communications, but the transmission line can be substituted for optical fibers to be used as a pair of transmission media for upstream and downstream communications.

Each of the communication paths 61 to 63 is established upon starting exchanges of GMPLS generalized RSVP-TE messages among the network units 51 to 59 through a control message transferring network 2. In this first embodiment, 3 2-hop communication paths 61 to 63 are established, but the number of hops and the number of communication paths can be decided freely. Control message transferring nodes A 501 and B 502 are communication units such as IP routers, layer 2 switches, etc. In this first embodiment, the control message transferring network 2 consists of two control message transferring nodes 501 and 502, but the number of nodes and the topology can be decided freely.

Each of the network units 51 to 59 is given an identifier for identifying itself. Their identifiers are defined as “sw_a to sw_i” here.

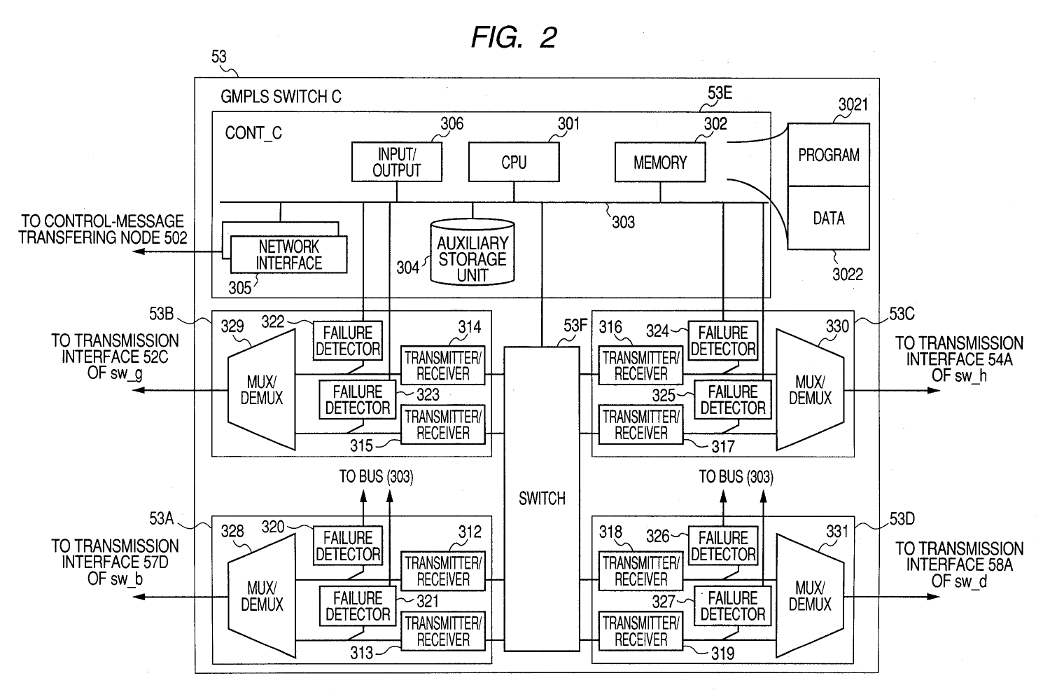

Next, a configuration of the network unit 53 will be described with reference to FIGS. 1 and 2. The configurations of other network units 51 to 52, as well as 54 to 59 are all the same as that of this network unit 53.

The network unit 53 includes interface units 53A to 53D, a switch unit 53F, and a control unit 53E. The transmission lines 31, 32, as well as 36 and 37 are connected to the interface units 53A and 53D, and to 53B and 53C respectively. The switch unit 53F switches among the interface units 53A to 53D to transfer signals from an interface unit to another, thereby setting a communication path.

The control unit 53E controls the switching (rerouting) operation of the switch unit 53F. The control unit 53E also interprets GMPLS generalized RSVP-TE messages.

Each of the interface units of the network units 51 to 59 is given an identifier. The three interface units 51A to 51C of the network unit 51 are given (IF_ID=if1) to (IF_ID=if3) as their identifiers. The three interface units 52a to 52c of the network unit 52 are given (IF_ID=if1) to (IF_ID=if3) as their identifiers. The four interface units 53A to 53D of the network unit 53 are given (IF_ID=if1) to (IF_ID=if4) as their identifiers. The three interface units 54A to 54C of the network unit 54 are given (IF_ID=if1) to (IF_ID=if3) as their identifiers. The three interface units 55A to 55C of the network unit 55 are given (IF_ID=if1) to (IF_ID=if3) as their identifiers. The two interface units 56A to 56B of the network unit 56 are given (IF_ID=if1) to (IF_ID=if2) as their identifiers. The four interface units 57A to 57D of the network unit 57 are given (IF_ID=if1) to (IF_ID=if4) as their identifiers. The four interface units 58A to 58D of the network unit 58 are given (IF_ID=if1) to (IF_ID=if4) as their identifiers. Also, the two interface units 59A to 59B of the network unit 59 are given (IF_ID=if1) to (IF_ID=if2) as their identifiers.

Each interface unit uses two wavelengths to send/receive signals and label 1 and label 2 are given to those two wavelengths respectively. In this first embodiment, each of the network units 51 to 59 includes two to four interface units, but the number of interface units can be decided freely. Although each interface unit uses two wavelengths to receive signals as described above, the number of wavelengths can also be decided freely.

Next, hardware configurations of the interface units 53A (IF_ID=if1) to 53D (IF_ID=if4) are described. Here, the configuration of only the interface unit 53A is picked up as an example, but the configurations of all of other interface units 53B to 53D are the same as that of this network unit 53A.

The interface unit 53A includes a MUX/DEMUX 328, signal transmitters/receivers 312 to 313, and failure detection units 320 to 321.

The MUX/DEMUX 328 has a signal separating function and receives signals from the transmission line 31, then separates received signals into individual signals according to each wavelength and sends each wavelength signal to the transmitters/receivers 312 to 313. The transmitters/receivers 312 to 313 transfer received signals to a switching unit 53F. The MUX/DEMUX 328 also has a signal synthesizing function and receives signals from the transmitters/receivers 312 to 313 and synthesizes a certain number of received signals into a signal to be sent to the transmission line 31. In this case, the transmitters/receivers 312 to 313 transfer the synthesized signals to the MUX/DEMUX 328. The switching unit 53F sends those signals to the interface unit 53D corresponding to an established communication path.

Each of the failure detection units 320 to 321 detects a failure in an object communication path by measuring the subject signal.

Next, a hardware configuration of a control unit 53E of the interface unit 53A will be described. The control unit 53E includes a CPU 301, a memory 302, an internal communication line 303 such as a bus or the like, a communication interface 305, an auxiliary storage unit 304, and an input/output unit 306.

The communication interface 305 is connected to a control message transferring node 502 to exchange GMPLS generalized RSVP-TE messages with remote network units 51 to 59. The internal communication line 303 is connected to the switching unit 53F and to the interface units 53A to 53D to exchange control signals with the interface units 53A to 53D. The memory 302 stores a program including procedures used to control the communication interface 305, the failure detection units 320 to 327, and the switching unit 53F.

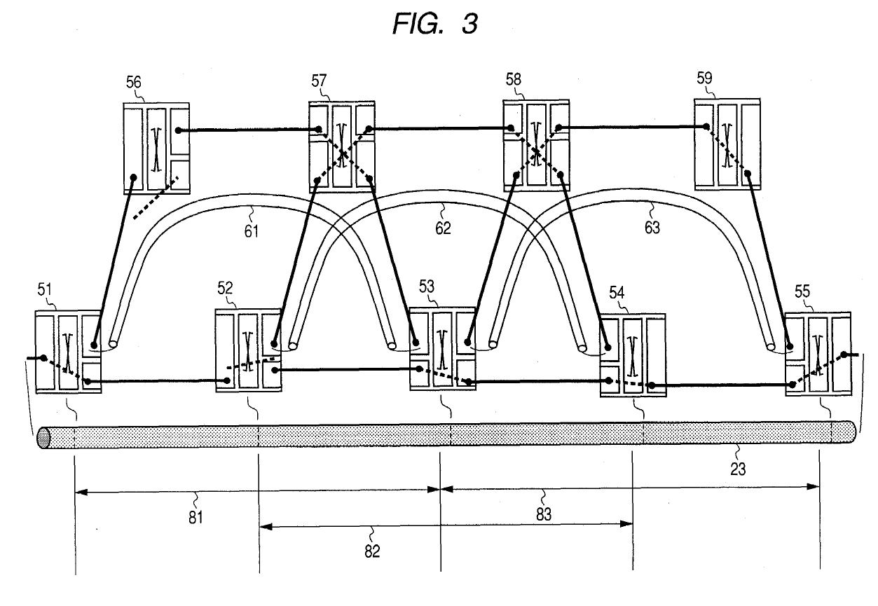

Hereunder, an example of a communication path established in a network 1 in this first embodiment will be described with reference to FIG. 3.

FIG. 3 shows a state in which a communication path 23 is established. When a communication path is established, communication paths 61 to 63 are also established as failure recovery paths to prepare for occurrence of communication failures. The communication path 23 used in normal communications is referred to as a primary path and each of communication paths 61 to 63 used upon occurrence of a failure in the primary path 23 is referred to as a secondary path. Each of segments 81 to 83 includes corresponding one of the secondary paths 61 to 63 and a section of the primary path 23, protected by the corresponding one of the secondary paths 61 to 63.

When an attention is paid to a GMPLS switch, a segment of which GMPLS switch is assumed as a starting point is referred to as a self-node control segment. In FIG. 3, the segment 82 is a self-node control segment of the network unit 52 (sw_b)

When an attention is paid to a network unit (GMPLS switch), a downstream segment nearest to the self-GMPLS switch is referred to as the nearest downstream segment. In FIG. 3, the segment 82 is the nearest downstream segment of the network unit 51 (sw_a).

When an attention is paid to a GMPLS switch, a downstream segment nearest to the self-node control segment of the self-GMPLS switch and not overlapped on the switch is referred to as the nearest non-overlapped downstream segment. In FIG. 3, the segment 83 is the nearest non-overlapped downstream segment of the network unit 51 (sw_a).

When an attention is paid to a GMPLS switch, an upstream segment nearest to the self-node control segment of the self-GMPLS switch and not overlapped on the segment is referred to as the nearest non-overlapped upstream segment. In FIG. 3, the segment 81 is the nearest non-overlapped upstream segment of the network unit 54 (sw_c).

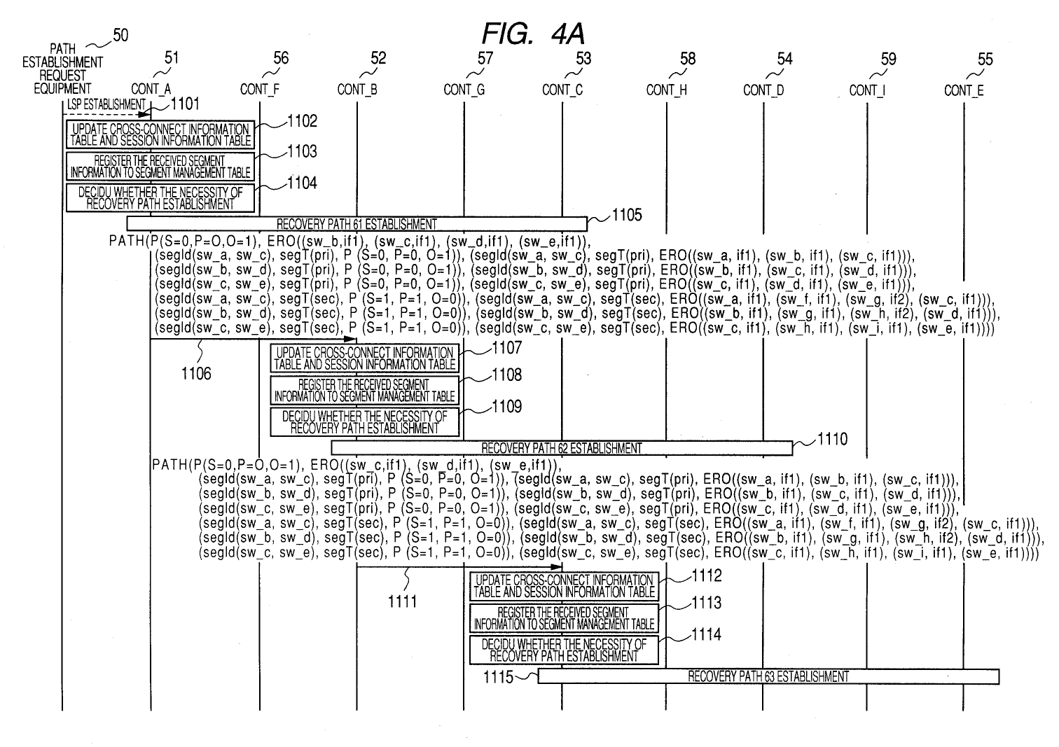

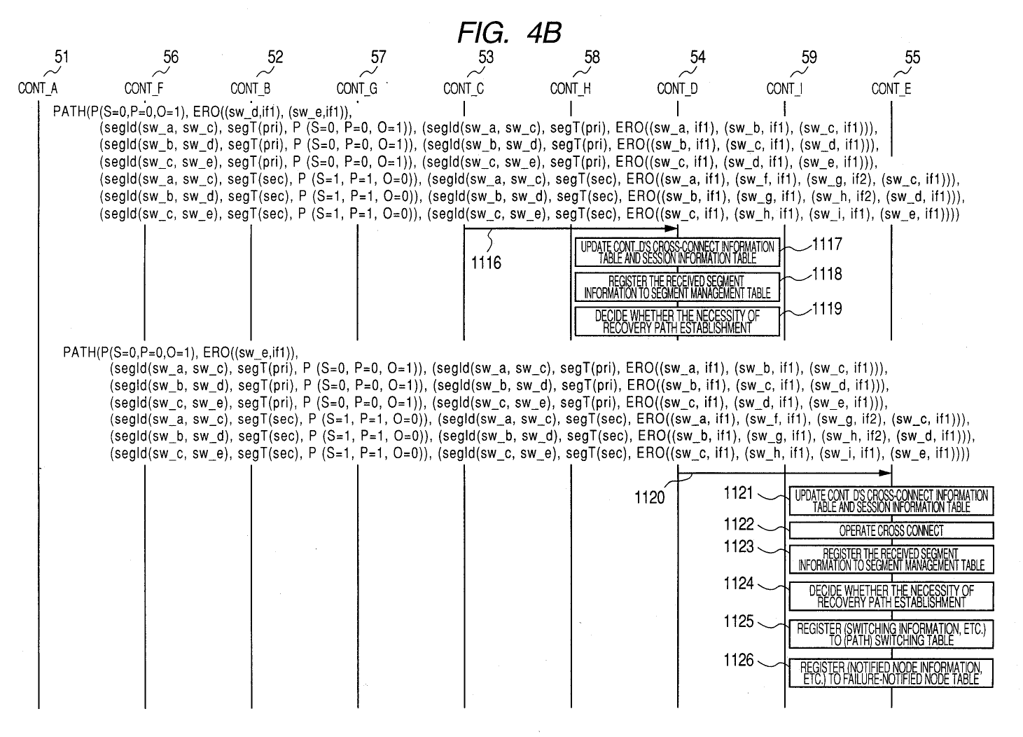

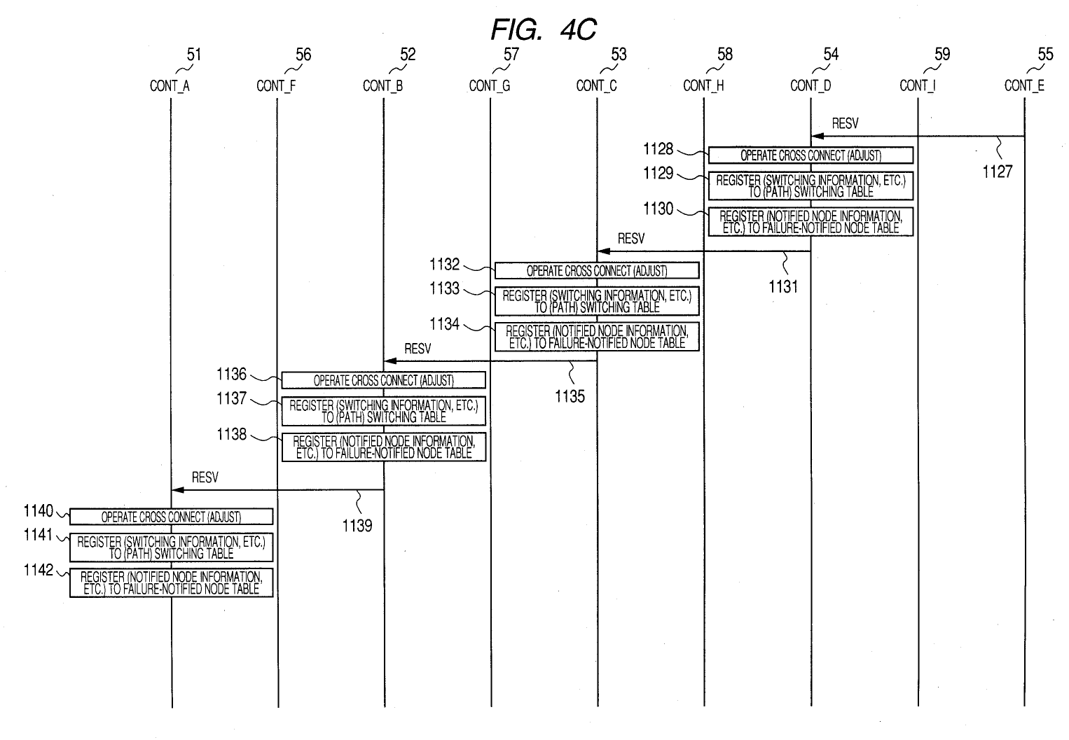

Next, a series of sequences for establishing a primary path will be described with reference to FIGS. 4A through 4C. FIGS. 4A through 4C show the series of sequences for establishing the primary path.

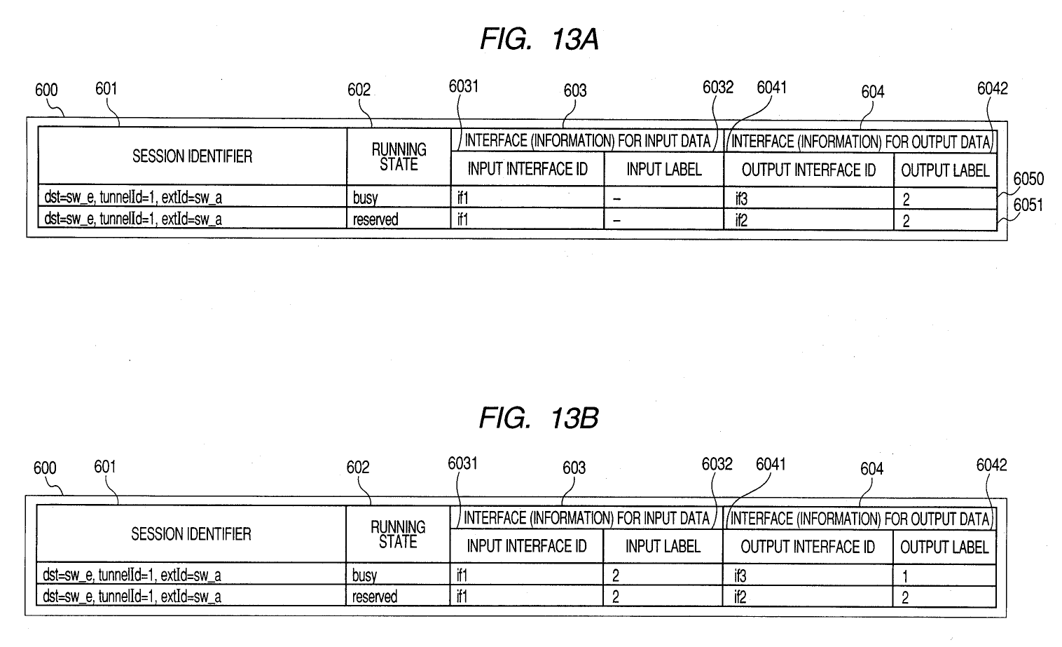

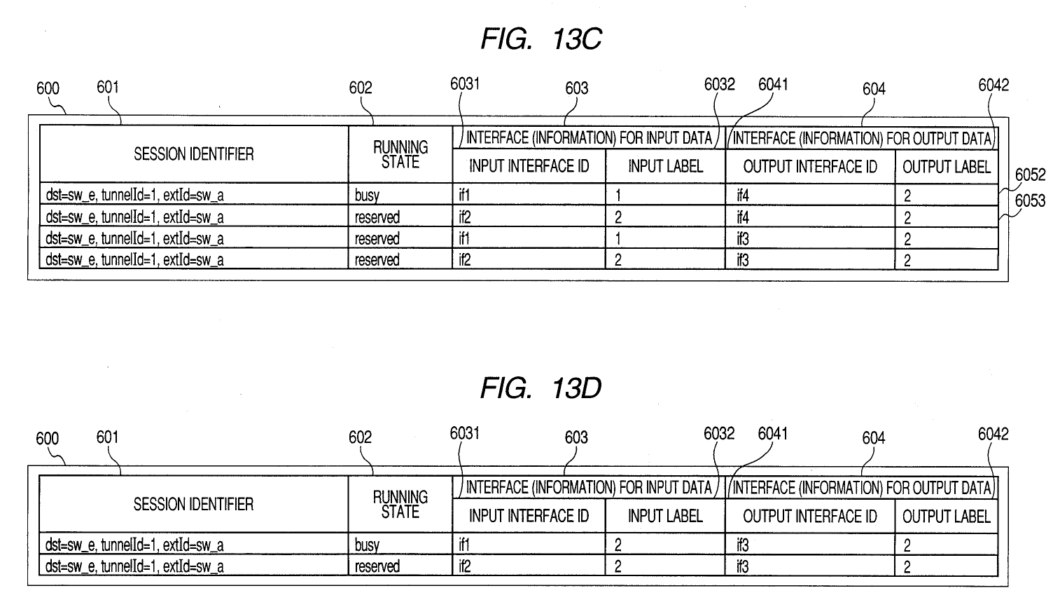

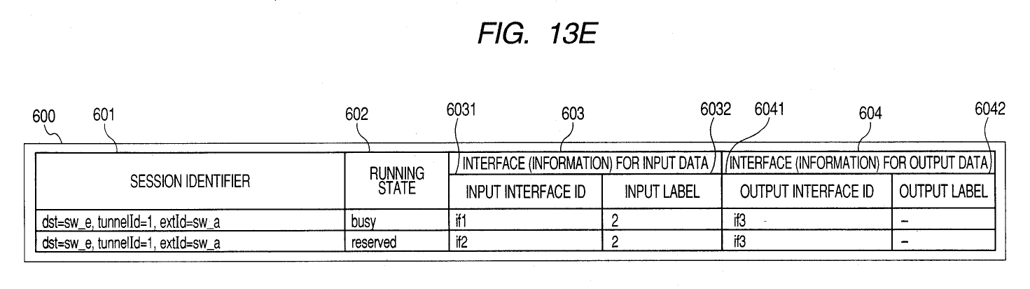

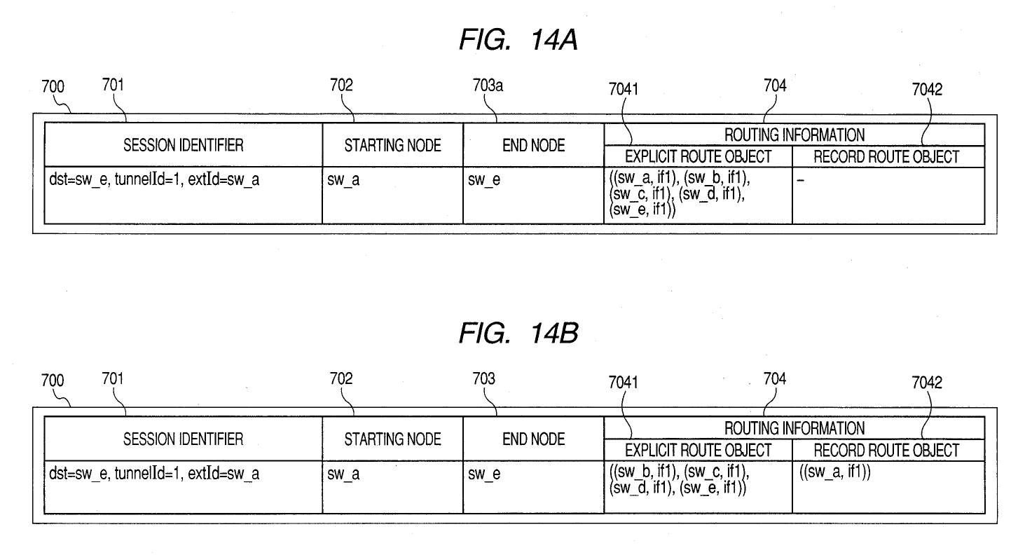

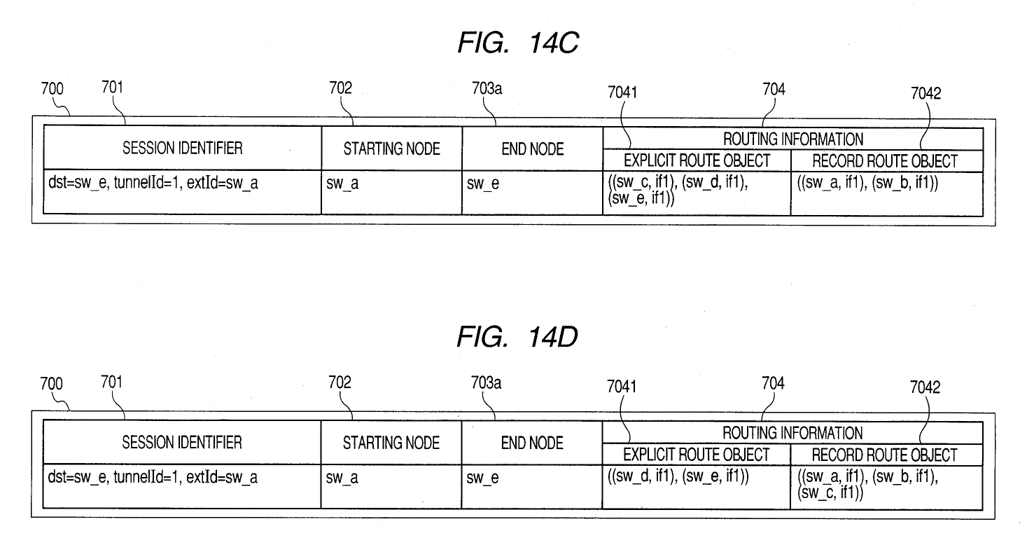

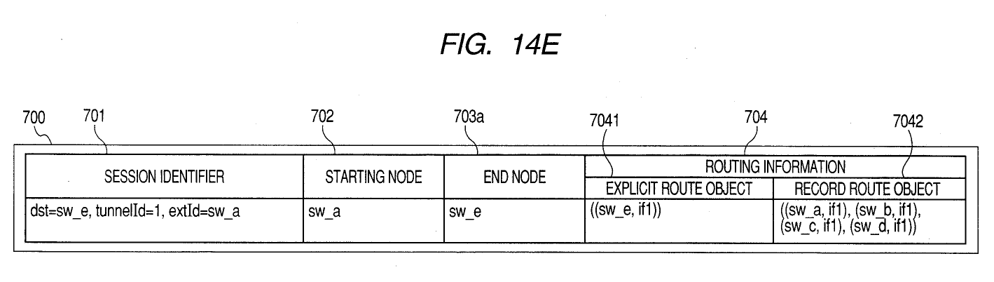

The control unit 51E (CONT_A) of the network unit 51, upon receiving an establishment request for the primary path including a route between the network units 51 and 55, assigns a resource and registers the resource in a session information table 700 and in a cross-connect information table 600 respectively (1102). FIGS. 14A and 13A shows the contents of those tables in which the resource is registered in step 1102.

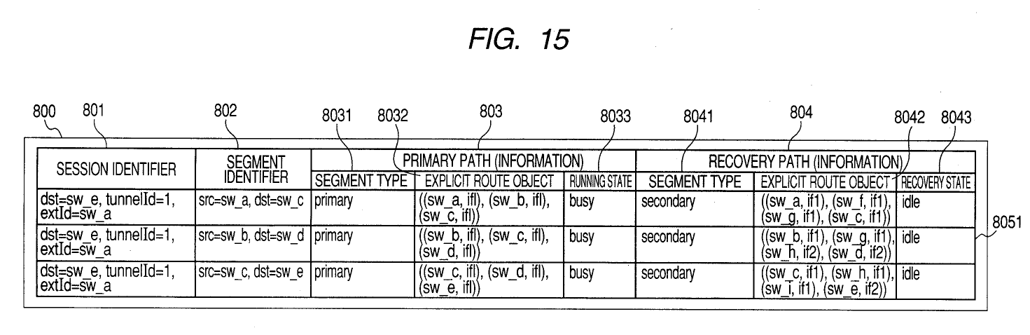

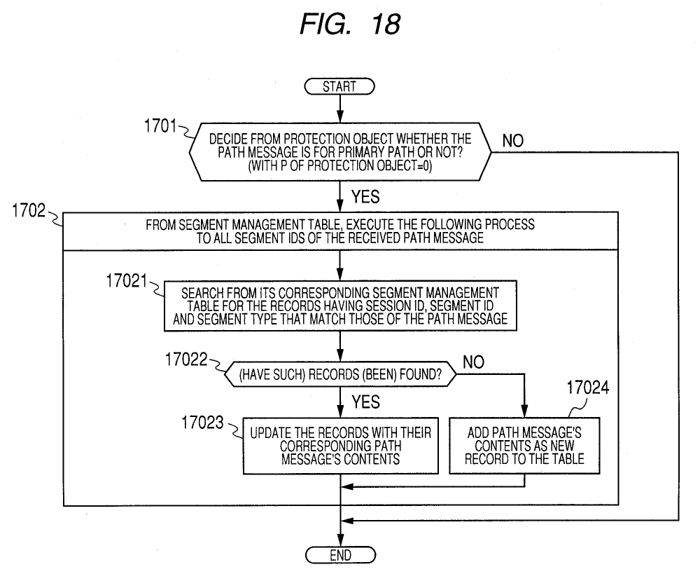

After that, the control unit 51E registers the segment information in the segment management table 800 (1103). How to register the segment information in the table 800 will be described later in detail with reference to FIG. 18. FIG. 15 shows the contents of the segment management table 800 after the registration processing in step 1103.

After that, the control unit 51E considers the necessity for establishing the primary path 61 (1104). Here, because it is required to establish the primary path 61, the control unit 51E establishes the primary path 61 (1105).

After that, the network unit 51 (sw_a) sends a PATH message to the network unit 52 (sw_b) (1106) through the primary path 23 to request a downstream node for assignment of a communication path. The PATH message includes generalized protection information that is generalized objects representing the segments 81 and 82, as well as generalized routing information.

The primary path information of the segment 81 includes protection information (segId(sw_a, sw_c), segT(pri), P(S=0, P=0, 0=1)) and routing information (segId(sw_a, sw_c), segT(pri), ER0((sw_a, if1), (sw_b, if1), (sw_c, if1)). Each of the protection information and the routing information includes a segment ID segId(sw_a, sw_c) of the segment 81 and a primary segment type segT(pri).

The primary path information of the segment 82 includes protection information (segId(sw_b, sw_d), segT(pri), P(S=0, P=0, 0=1)) and routing information (segId(sw_b, sw_d), segT(pri), ER0((sw_b, if1), (sw_c, if1), (sw_d, if1))). Each of the protection information and the routing information includes a segment ID segId(sw_b, sw_d) of the segment 82 and a primary segment type segT(pri).

The primary path information of the segment 83 includes protection information (segId(sw_c, sw_e), segT(pri), P(S=0, P=0, 0=1)) and routing information (segId(sw_c, sw_e), segT(pri), ER0((sw_c, if1), (sw_d, if1), (sw_e, if1)). Each of the protection information and the routing information includes a segment ID segId(sw_c, sw_e) of the segment 83 and a primary segment type segT(pri).

The recovery path information of the segment 81 includes protection information (segId(sw_a, sw_c), segT(sec), P(S=1, P=1, 0=0)) and routing information (segId(sw_a, sw_c), segT(sec), ER0((sw_a, if1), (sw_f, if1), (sw_g, if2), (sw_c, if1))). Each of the protection information and the routing information includes a segment ID segId(sw_a, sw_c) of the segment 81 and a secondary segment type segT (sec). The recovery path routing information denotes a recovery route.

The recovery path information of the segment 82 includes protection information (segId(sw_b, sw_d), segT(sec), P(S=1, P=1, 0=0)) and routing information (segId(sw_b, sw_d), segT(sec), ER0((sw_b, if1), (sw_g, if1), (sw_h, if2), (sw_d, if1))). Each of the protection information and the routing information includes a segment ID segId(sw_b, sw_d) of the segment 82 and a secondary segment type segT(sec).

The recovery path information of the segment 83 includes protection information (segId(sw_c, sw_e), segT(sec), P(S=1, P=1, 0=0)) and routing information (segId(sw_c, sw_e), segT(sec), ER0((sw_c, if1), (sw_h, if1), (sw_i, if1), (sw_e, if1))). Each of the protection information and the routing information includes a segment ID segId(sw_b, sw_d) of the segment 83 and a secondary segment type segT(sec). The generalized object includes a segment ID (segID) for distinguishing a segment from others and a segment type (segT)

Then, the network unit 52, upon receiving the PATH message, assigns a resource and registers the resource in the session information table 700 and in the cross-connect information table 600 respectively (1107). FIGS. 14B and 13B show the contents in those tables after the registration processing in step 1107.

Then, the network unit 52 registers the segment information in the segment management table 800 (1108). How to register the segment information in the table 800 will be described later in detail with reference to FIG. 18. FIG. 15 shows the contents of the table 800 after the registration processing in step 1108.

After that, the network unit 52 considers the necessity for establishing a recovery path (1109). Because it is required to establish a recovery path here, the network unit 52 establishes the recovery path 62 (1110).

After that, the network unit 52 (sw_b) sends a PATH message to the network unit 53 (sw_c) (1111).

Upon receiving the PATH message, the network unit 53 assigns a resource and registers the resource in the session information table 700 and in the cross-connect information table 600 respectively (1112). FIGS. 14C and 13C show the contents in those tables after the registration processing in step 1112.

Then, the network unit 53 registers the segment information in the segment management table 800 (1113). How to register the segment information in the table 800 will be described later in detail with reference to FIG. 18. FIG. 15 shows the contents of the table 800 after the registration processing in step 1113.

After that, the network unit 53 considers the necessity for establishing a recovery path (1114). Because it is required to establish a recovery path here, the network unit 53 establishes the recovery path 63 (1115).

After that, the network unit 53 (sw_c) sends a PATH message to the network unit 54 (sw_d) (1116).

Upon receiving the PATH message, the network unit 54 assigns a resource and registers the resource in the session information table 700 and in the cross-connect information table 600 respectively (1117). FIGS. 14D and 13D show the contents in those tables after the registration processing in step 1117.

Then, the network unit 54 registers the segment information in the segment management table 800 (1118). How to register the segment information in the table 800 will be described later in detail with reference to FIG. 18. FIG. 15 shows the contents of the table 800 after the registration processing in step 1118.

After that, the network unit 54 considers the necessity for establishing a recovery path (1119). As a result of the consideration, the network unit 54 decides that there is no need to establish a recovery path.

Finally, the network unit 54 (sw_d) sends a PATH message to the network unit 55 (sw_e) (1120).

Upon receiving the PATH message, the network unit 55 assigns a resource and registers the resource in the session information table 700 and in the cross-connect information table 600 respectively (1121). FIGS. 14E and 13E show the contents in those tables after the registration processing in step 1121.

Then, the network unit 53 executes cross connect controlling (1122). After this, the network unit 55 registers the segment information in the segment management table 800 (1123). How to register the segment information in the table 800 will be described later in detail with reference to FIG. 18. FIG. 15 shows the contents of the table 800 after the registration processing in step 1123.

After that, the network unit 55 considers the necessity for establishing a recovery path (1124). As a result of the consideration, the network unit 55 decides that there is no need to establish a recovery path.

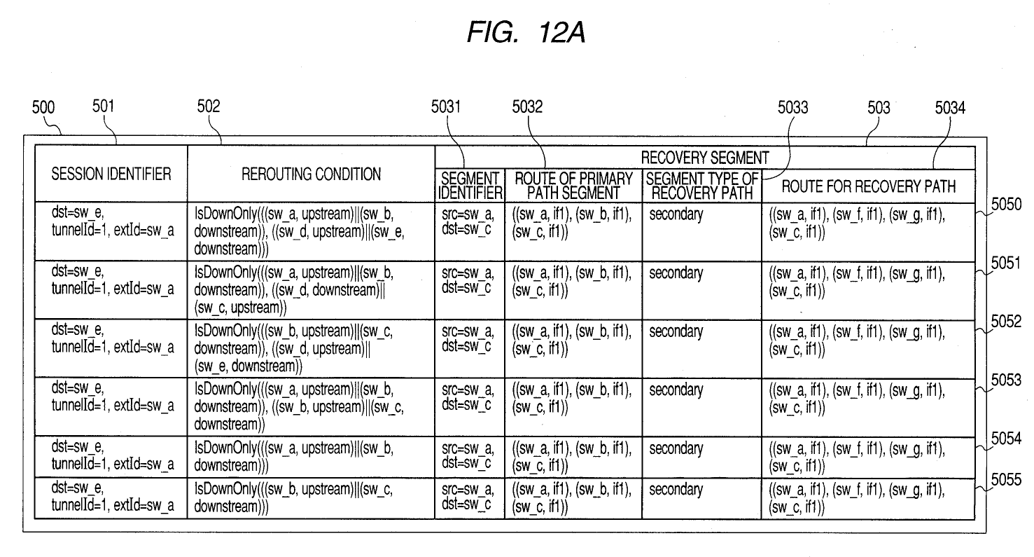

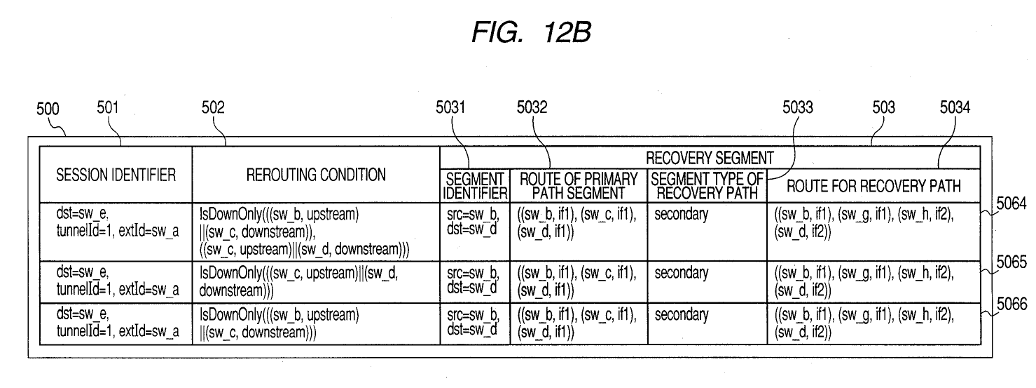

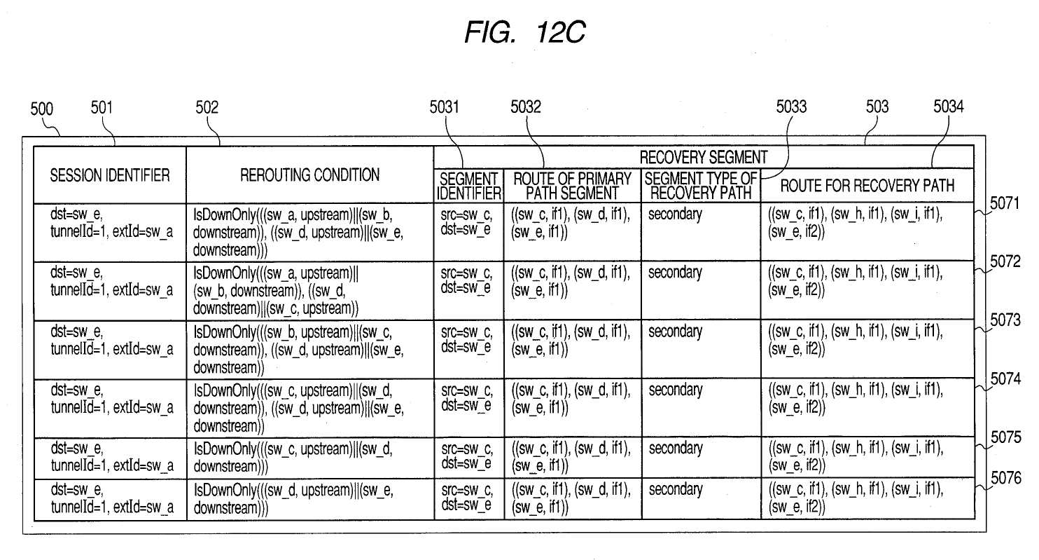

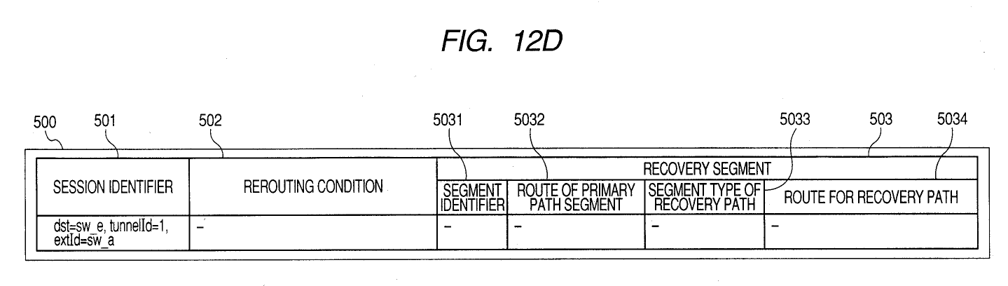

Then, the network unit 55 registers the path rerouting condition in the rerouting table 500 (1125). FIG. 12D shows the contents of the rerouting table after the registration processing in step 1125.

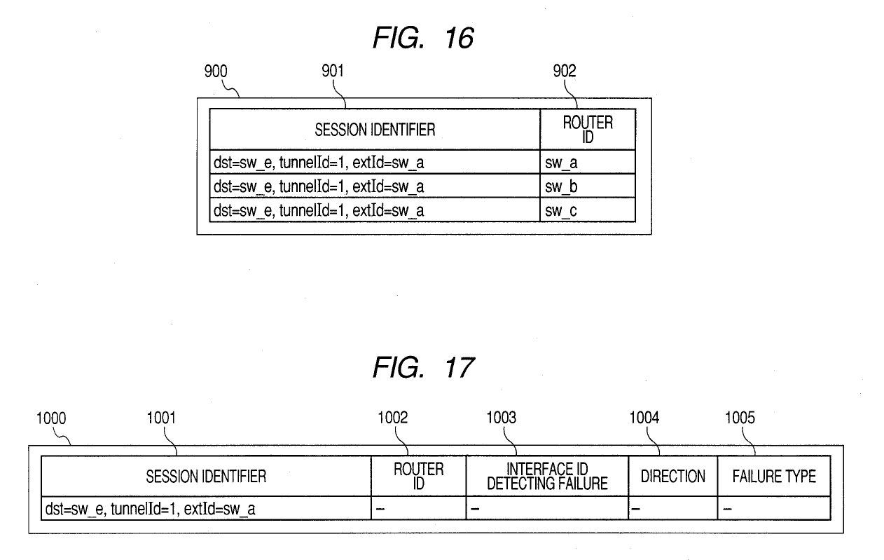

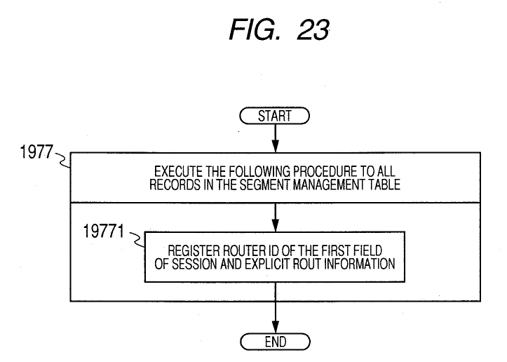

After that, the network unit 55 registers nodes for failure notification in a failure notification address table 900 (1126). How to register those nodes for failure notification in the failure notification address table 900 will be described later in detail with reference to FIG. 23. FIG. 16 shows the contents of the table 900 after the registration processing in step 1126.

Then, the receiving side of the PATH message for requesting assignment of a communication path returns a RESV message including information of both interface and label to the upward node (1127). For example, the network unit 55 sends a RESV message to the network unit 54 and the message includes the self-node value of the network unit 55. In other words, the interface 55a used for the communication is represented as (sw_e, if1).

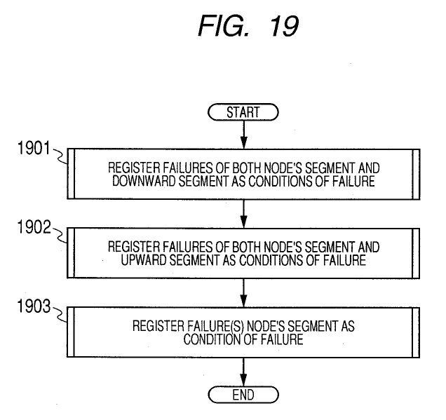

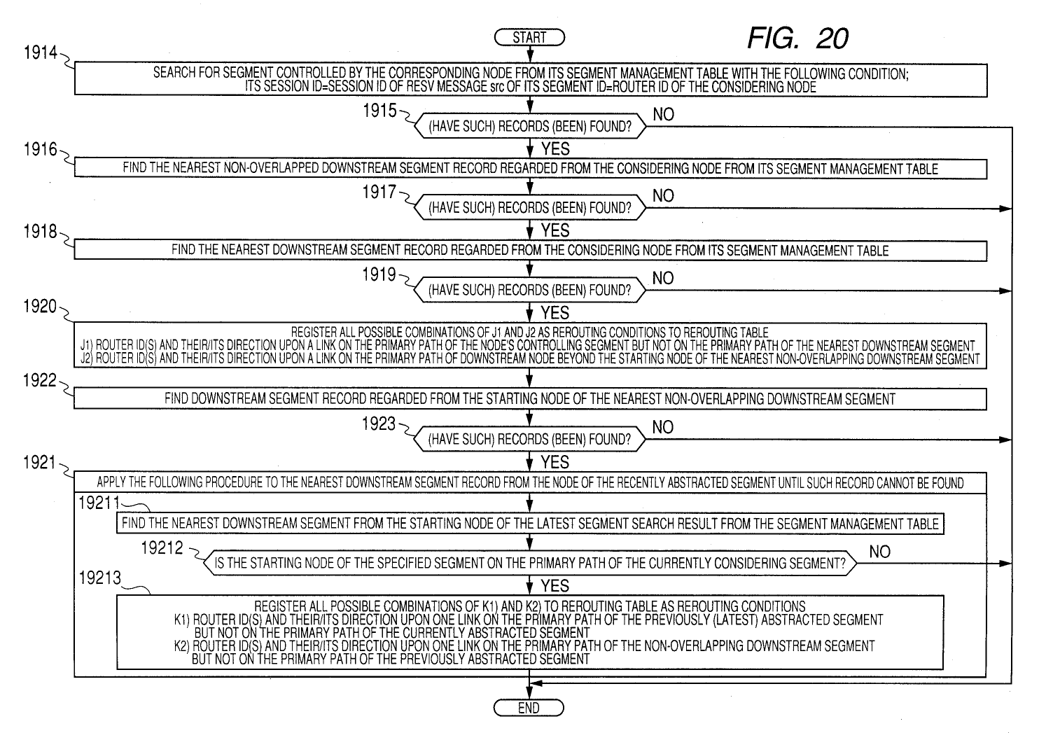

Upon receiving the RESV message, the network unit 54 executes cross-connect controlling (1128) and registers the rerouting condition in the rerouting table 500 (1129). How to register the rerouting condition in the table 500 will be described later in detail with reference to FIGS. 19 through 22. FIG. 12D shows the contents of the table 500 after the registration processing in step 1129.

After that, the network unit 54 registers the nodes for failure notification in the failure notification address table 900 (1130). How to register those nodes for failure notification in the table 900 will be described later in detail with reference to FIG. 23. FIG. 16 shows the contents of the table 900 after the registration processing in step 1130.

After that, the network unit 54 adds the self-node (network unit 54) related value to the received RESV message, then sends the value added message 1131 to the network unit 5 3. In other words, the interface 54A used for the communication is represented as (sw_d, if1).

Upon receiving the RESV message, the network unit 53 executes cross-connect controlling (1132) and registers the rerouting condition in the rerouting table 500 (1133). How to register the rerouting condition in the table 500 will be described later in detail with reference to FIGS. 19 through 22. FIG. 12C shows the contents of the table 500 after the registration processing in step 1133.

After that, the network unit 53 registers the nodes for failure notification in the failure notification address table 900 (1134). How to register those nodes for failure notification in the table 900 will be described later in detail with reference to FIG. 23. FIG. 16 shows the contents of the table 900 after the registration processing in step 1134.

Furthermore, the network unit 53 adds the self-node (network unit 53) related value to the received RESV message 1131, then sends the value added message 1135 to the network unit 52. In other words, the interface 53A used for the communication is represented as (sw_c, if1).

Upon receiving the RESV message 1135, the network unit 52 executes cross-connect controlling (1136) and registers the rerouting condition in the rerouting table 500 (1137). How to register the rerouting condition in the table 500 will be described later in detail with reference to FIGS. 19 through 22. FIG. 12B shows the contents of the table 500 after the registration processing in step 1137.

After that, the network unit 52 registers the nodes for failure notification in the failure notification address table 900 (1138). How to register those nodes for failure notification in the table 900 will be described later in detail with reference to FIG. 23. FIG. 16 shows the contents of the table 900 after the registration processing in step 1138.

Finally, the network unit 52 adds the self-node related value in the received RESV message 1135, then sends the value added message 1139 to the network unit 51. In other words, the interface 52A used for the communication is represented as (sw_b, if1).

Upon receiving the RESV message 1139, the network unit 51 executes cross-connect controlling (1140) and registers the rerouting condition in the rerouting table 500 (1141). How to register the rerouting condition in the table 500 will be described later in detail with reference to FIGS. 19 through 22. FIG. 12A shows the contents of the table 500 after the registration processing in step 1141.

After that, the network unit 51 registers the nodes for failure notification in the failure notification address table 900 (1142). How to register those nodes for failure notification in the table 900 will be described later in detail with reference to FIG. 23. FIG. 16 shows the contents of the table 900 after the registration processing in step 1142.

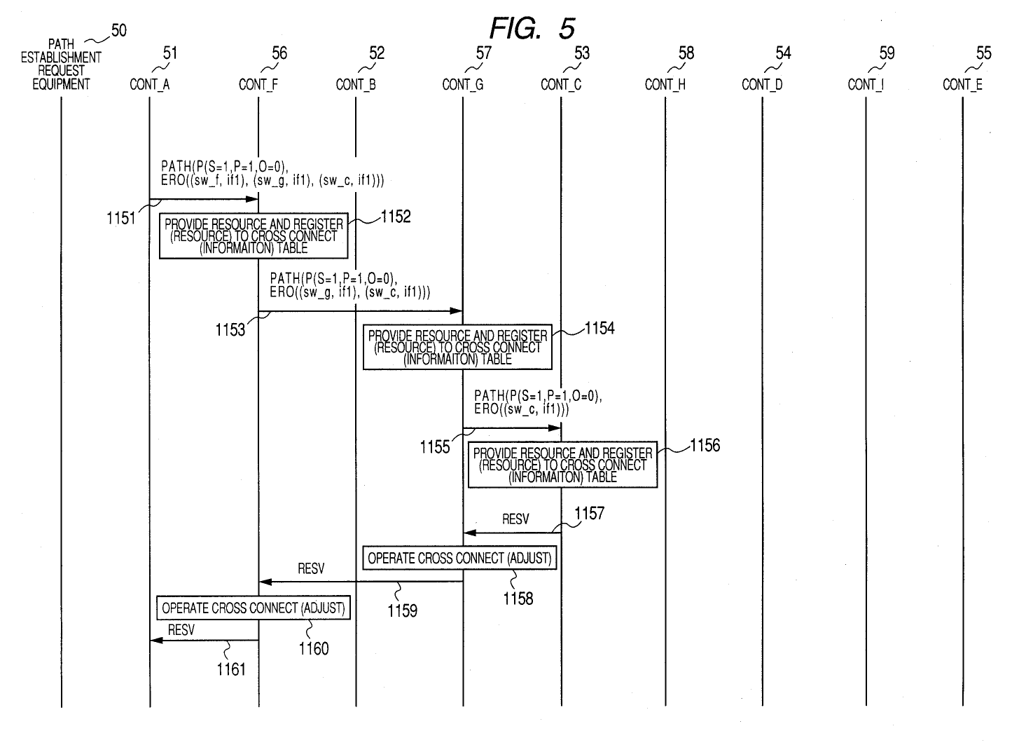

Next, a series of sequences for establishing the recovery path 61 will be described with reference to FIG. 5.

At first, the network unit 51 (sw_a) sends a PATH message to the network unit 56 (sw_f) in the downstream to request assignment of a communication path (1151). Receiving the PATH message 1151, the network unit 56 assigns a resource and registers the resource in the session information table 700 and in the cross-connect information table 600 respectively (1152).

Then, the network unit 56 (sw_f) sends a PATH message to the network unit 57 (sw_g) (1153). Receiving the PATH message 1153, the network unit 57 assigns a resource and registers the resource in the session information table 700 and in the cross-connect information table 600 respectively (1154).

Furthermore, the network unit 57 (sw_g) sends a PATH message to the network unit 53 (sw_c) (1155). Receiving the PATH message 1155, network unit 53 assigns a resource and registers the resource in the session information table 700 and in the cross-connect information table 600 respectively (1156).

Then, the receiving side of the PATH message for requesting assignment of a communication path returns a RESV message including information of both interface and label to the upstream node (1157). For example, the network unit 53 sends a RESV message 1157 to the network unit 57 and the message 1157 includes the self-node (network unit 53) related value. In other words, the interface 53B used for the communication is represented as (sw_c, if2) here.

Upon receiving the RESV message 1157, the network unit 57 executes cross-connect controlling (1158). Then, the network unit 57 adds its node related value to the received RESV message 1157, then sends the value added message 1159 to the network unit 56. In other words, the interface 57B used for the communication is represented as (sw_g, if2) here.

Upon receiving the RESV message 1159, the network unit 56 executes cross-connect controlling (1160) and adds its node related value to the received RESV message 1160, then sends the value added message 1161 to the network unit 51. In other words, the interface 56A used for the communication is represented as (sw_f, if1) here.

As described above, the method for establishing the recovery path 61 can also be applied to establish the recovery path 62 (1110) and the recovery path 63 (1115) respectively.

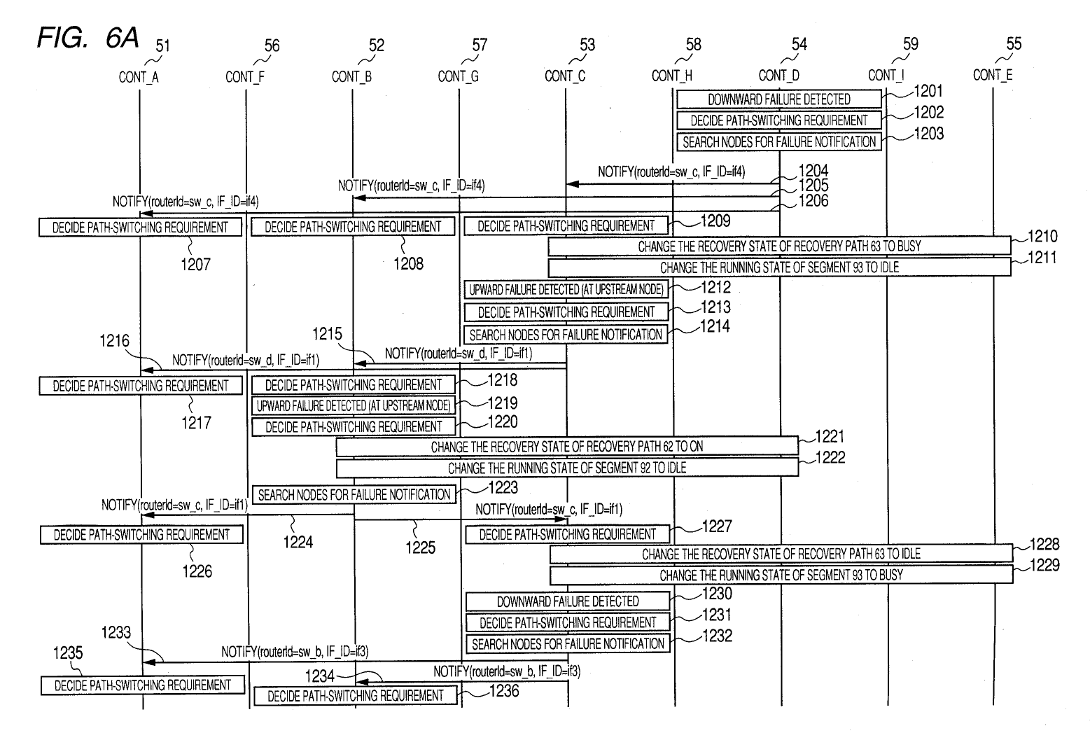

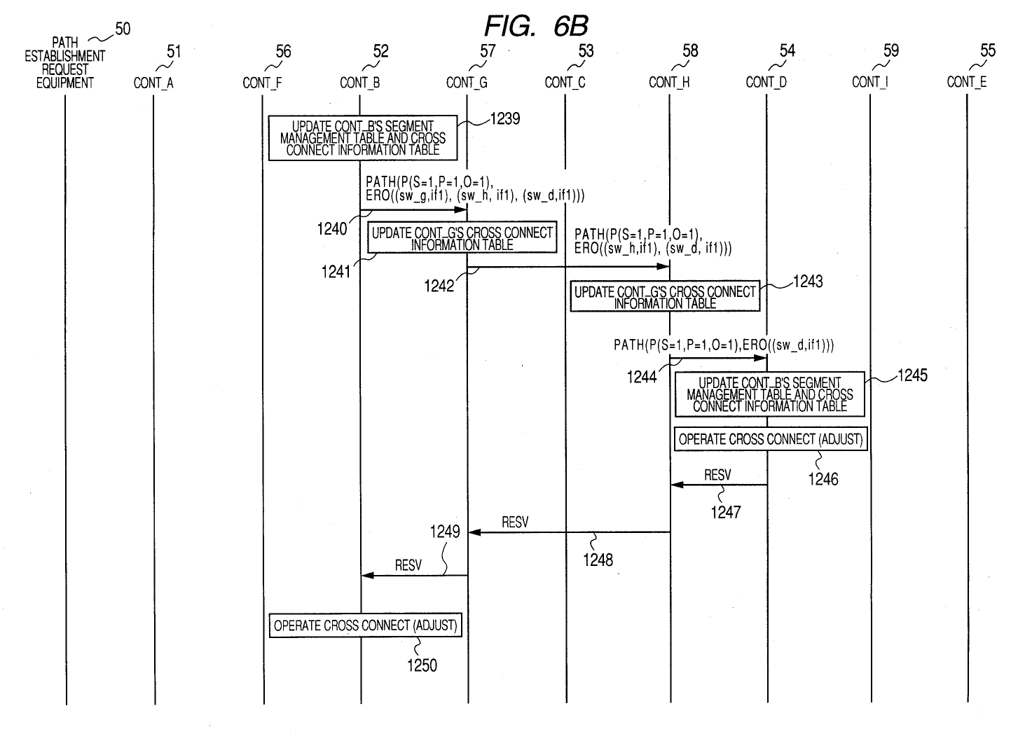

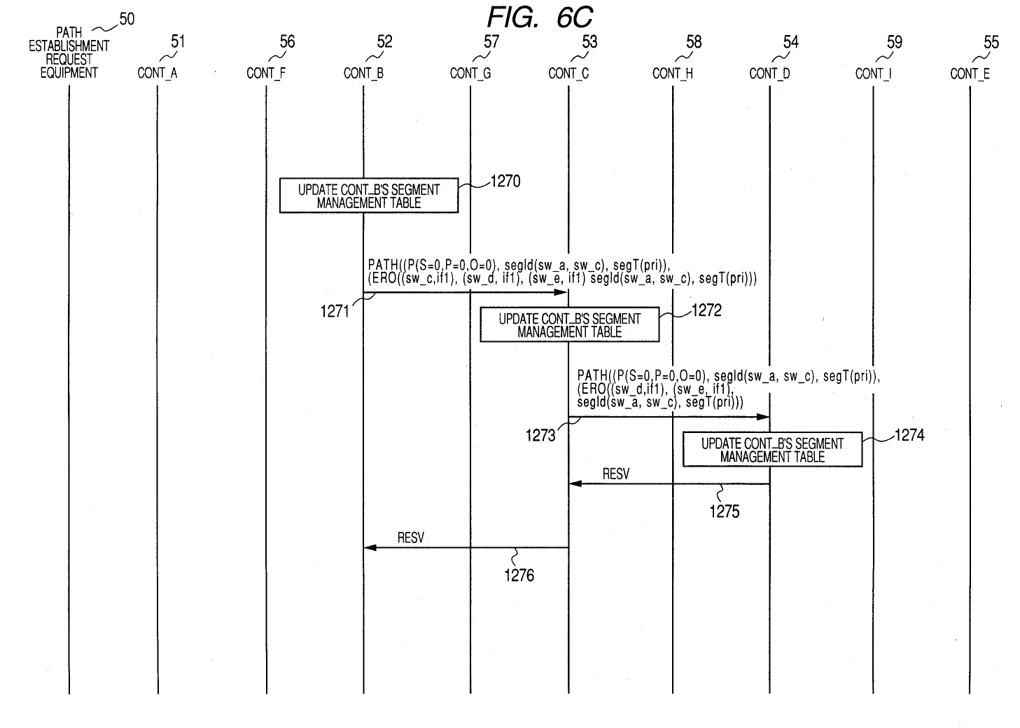

Next, a series of sequences for path switching caused by a link failure will be described with reference to FIG. 6A. FIG. 6A shows how a path is switched to another upon occurrence of failures in the links 31 and 32.

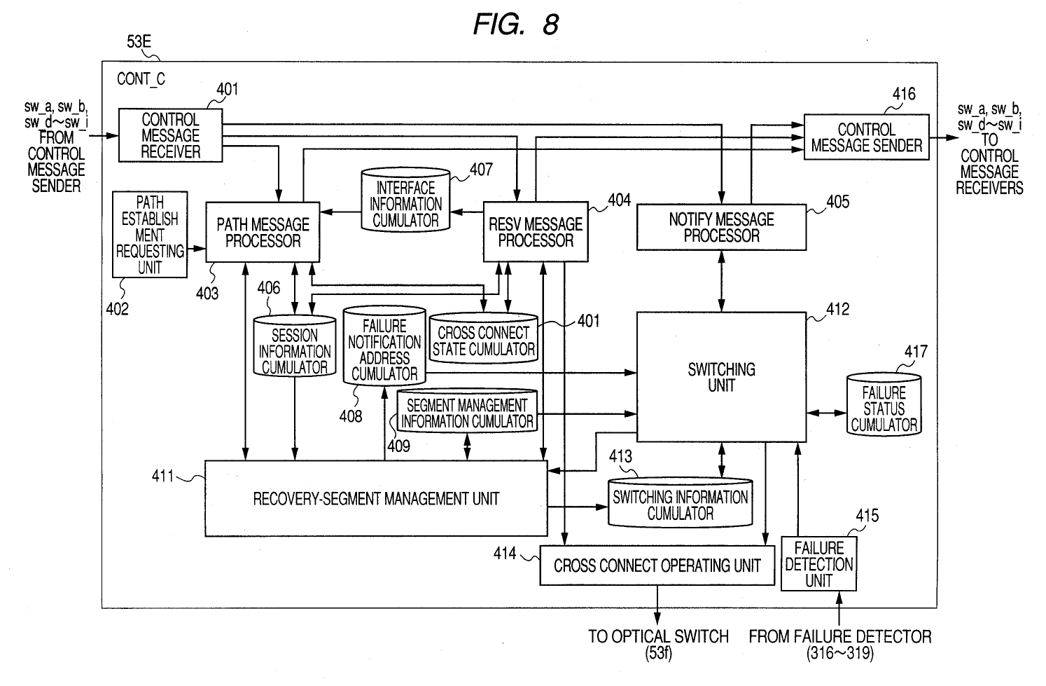

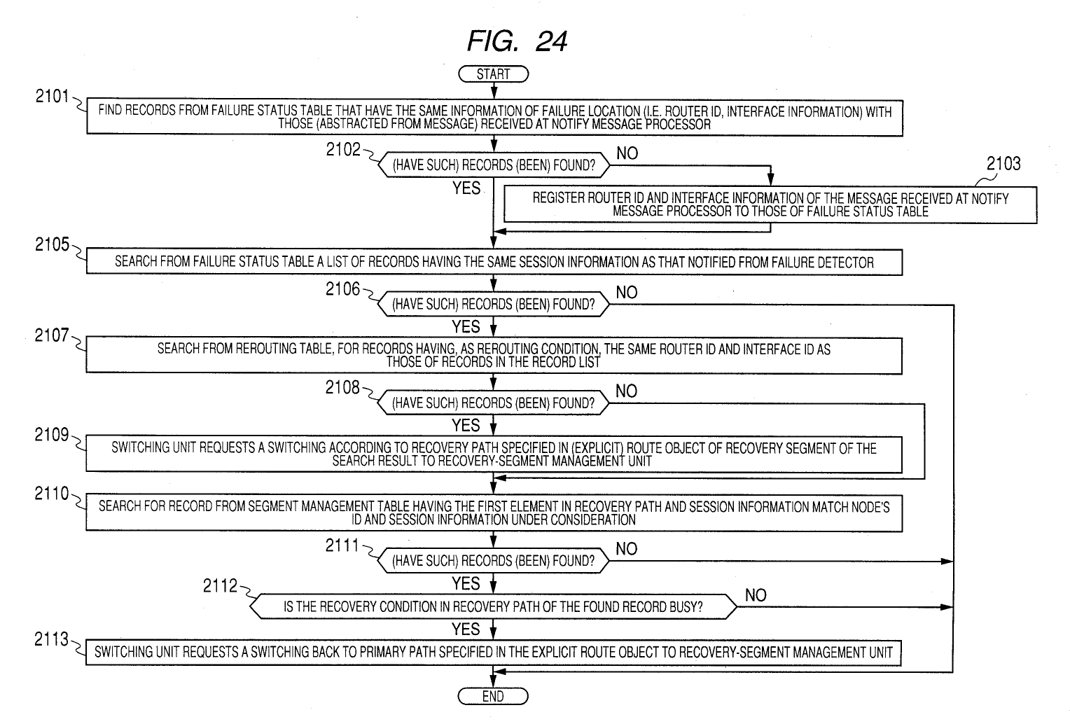

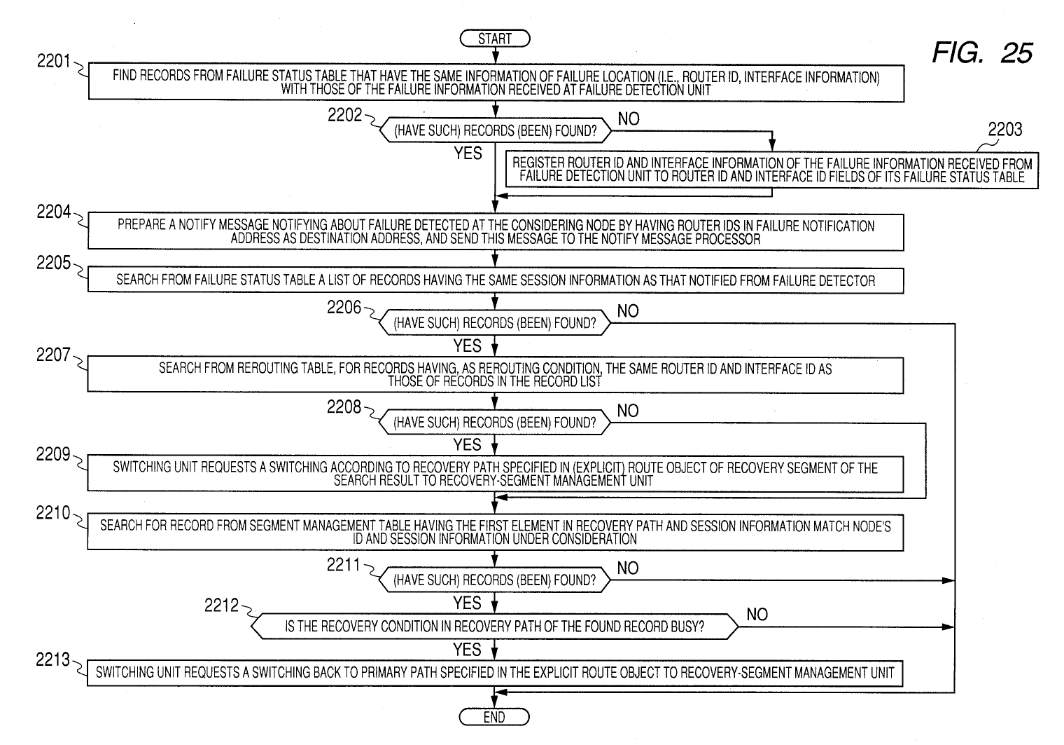

At first, the failure detection unit 415 (FIG. 8) of the network unit 54 detects a failure in the interface 53D just after a failure occurs in the link 32 (1201), then the switching unit 412 (FIG. 8) of the network unit 54 refers to the rerouting table 500 (FIG. 12D) and decides that there is no need to switch to a recovery path (1202). How the necessity of the switching to a recover path is decided will be described later in detail with reference to FIGS. 24 and 25.

A failure notification address accumulator 408 (FIG. 8) of the network 54 refers to the failure notification address table 900 (FIG. 16) (1203). As a result of the reference to the table 900, the control message sender 416 (FIG. 8) of the network unit 54 sends a NOTIFY message to the networks 51 and 53 respectively (1206,1205 and 1204).

Receiving the NOTIFY message (1206), the control unit 51E (CONT_A) of the network unit 51 refers to the rerouting table 500 (FIG. 12A) and decides that there is no need to make switching to a recovery path (1207).

Receiving the NOTIFY message (1205), the control unit 52E (CONT_A) of the network unit 52 refers to the rerouting table 500 (FIG. 12B) and decides that there is no need to make switching to a recovery path (1208).

Receiving the NOTIFY message (1204), the control unit 53E (CONT_B) of the network unit 53 refers to the rerouting table 500 (FIG. 12C) and decides the necessity of switching to a recovery path (1209). The control unit 53E then sets “busy” for the recovery status of the recovery path 63 (1210) and sets “idle” for the primary path running state of the segment 83 (1211).

When the failure detection unit 415 (FIG. 8) of the network unit 53 detects a failure in the interface 54A just after the failure detection in the link 32 (1212), the switching unit 412 (FIG. 8) of the network unit 53 refers to the rerouting table 500 (FIG. 12C) and decides the necessity of switching to a recovery path. However, because switching to a recovery path is already finished, the switching unit 412 decides that there is no need to make switching newly to a recovery path (1213). How to make such a decision for switching to a recovery path will be described later with reference to FIGS. 24 and 25. After that, the failure notification address accumulator 408 (FIG. 8) refers to the failure notification address table 900 (FIG. 16) (1214). According to the result of the reference to the table 900, the control message transmitter 416 (FIG. 8) of the network unit 53 sends a NOTIFY message to the network units 52 and 51 respectively (1215 and 1216).

Receiving the NOTIFY message 1216, the control unit 51E (CONT_A) of the network unit 51 refers to the rerouting table 500 (FIG. 12A) and decides that there is no need to make switching to a recovery path (1217). The control unit 52E (CONT_B) of the network unit 52, upon receiving the NOTIFY message 1215, refers to the rerouting table 500 (FIG. 12B) and decides that there is no need to make switching to a recovery path (1218). How to make such a decision for the necessity of switching to a recovery path will be described in detail later with reference to FIGS. 24 and 25.

After that, the failure detection unit 415 (FIG. 8) of the network unit 52 detects a failure in the interface 53A just after failure occurrence in the link 31 (1219), then the switching unit 412 (FIG. 8) of the network unit 52 refers to the rerouting table 500 (FIG. 12B) and decides the switching to the recovery path 62 (1220). Then, the network unit 52 sets “busy” for the recovery state of the recovery path 62 (1221) and “reserved” for the running state of the primary path of the segment 82 (1222) respectively.

The failure notification address accumulator 408 (FIG. 8) of the network unit 52 then refers to the failure notification address table 900 (1223). As a result, the control message transmitter 416 (FIG. 8) of the network unit 52 sends a NOTIFY message to the network units 51 and 53 respectively (1224 and 1225).

Receiving the NOTIFY message 1224, the control unit 51E (CONT_A) of the network unit 51 refers to the rerouting table 500 (FIG. 12A) and decides that there is no need to make switching to a recovery path (1226). The control unit 53E (CONT_C) of the network unit 53, upon receiving the NOTIFY message 1225, refers to the rerouting table 500 (FIG. 12C) and decides the necessity of switching back to the primary path of the segment 83 (1227).

Thus the control unit 53E (CONT_C) of the network unit 53 sets “idle” for the recovery state of the recovery path 63 of the segment management table 800 (1228) and “busy” for the running state of the primary path of the segment 83 (1229).

Finally, the failure detection unit 415 (FIG. 8) of the network unit 53 detects a failure in the interface 52C just after failure occurrence in the link 31 (1230). Then, the switching unit 412 (FIG. 8) of the network unit 53 refers to the rerouting table 500 (FIG. 12B) and decides that there is no need to make switching to a recovery path (1231). How to make such a decision for the necessity of switching to a recovery path will be described in detail later with reference to FIGS. 24 and 25.

The failure notification address accumulator 408 (FIG. 8) of the network unit 53 then refers to the failure notification address table 900 (FIG. 16) (1232). As a result, the control message transmitter 416 (FIG. 8) of the network unit 53 sends a NOTIFY message to the network units 51 and 52 respectively (1233 and 1234).

Receiving the NOTIFY message 1233, the control unit 51E (CONT_A) of the network unit 51 refers to the rerouting table 500 (FIG. 12A) and decides that there is no need to make switching to a recovery path (1235). The control unit 52E (CONT_B) of the network unit 52, upon receiving the NOTIFY message 1234, refers to the rerouting table 500 (FIG. 12B) and decides that there is no need to make switching to a recovery path (1236).

Path failures in the links 31 and 32 are thus recovered due to the witching to the recovery path 62 as described above.

Next, a description will be made for a series of sequences for changing the recovery state of a recovery path to “on” with reference to FIG. 6B.

At first, the network unit 52 sets “busy” for the recovery state 8043 of a record having the same segment ID (src=sw_b, dst=sw_d) as that in the segment management table 800 (FIG. 15) and update the cross-connect information table 600 (1239). Then, the network unit 52 sends a PATH message of the recovery path 62 to the network unit 57 (1240).

Then, the network unit 57 updates the cross-connect information table 600 (1242) and sends a PATH message of the recovery path 62 to the network unit 58 (1242). The network unit 58 then updates the cross-connect information table 600 (1243) and sends a PATH message of the recovery path 62 to the network unit 54 (1244).

After that, at the receiving side of the PATH message for requesting assignment of a communication path, the network unit 54 sets “busy” for the recovery state 8043 of the record having the segment ID (src=sw_b, dst=sw_d) set in the segment management table 800 and updates the cross-connect information table 600 (1245). Then, the network unit 54 begins cross-connect controlling (1246).

The network unit 54 then returns a RESV message that includes information of both interface and label to the object upstream node (network unit) (1247). For example, the network unit 54 sends a RESV message to the network unit 58.

After that, the network unit 58 sends a RESV message to the network unit 57 (1248). Then, the network unit 57 sends a RESV message to the network unit 52 (1249). Receiving the RESV message, the network unit 52 begins cross-connect controlling (1250).

Next, a description will be made for a series of sequences for changing the running state of the primary path of the segment 82 to “reserved” with reference to FIG. 6C.

At first, the network unit 52 sets “idle” for the running state 8033 of the segment management table 800 (FIG. 15) (1270) and sends a PATH message that includes updated information of the segment 82 to the network unit 53 (1271). Then, the network unit 52 sets “idle” for the running state 8033 of the segment management table 800 (FIG. 15) (1270) and sends a PATH message that includes updated information of the segment 82 to the network unit 54 (1273).

After that, at the receiving side of the PATH message for requesting assignment of a communication path, the network unit 54 returns a RESV message that includes information of both interface and label to the object network unit in the upstream (1275). For example, the network unit 54 sends the RESV message to the network unit 52 (1276).

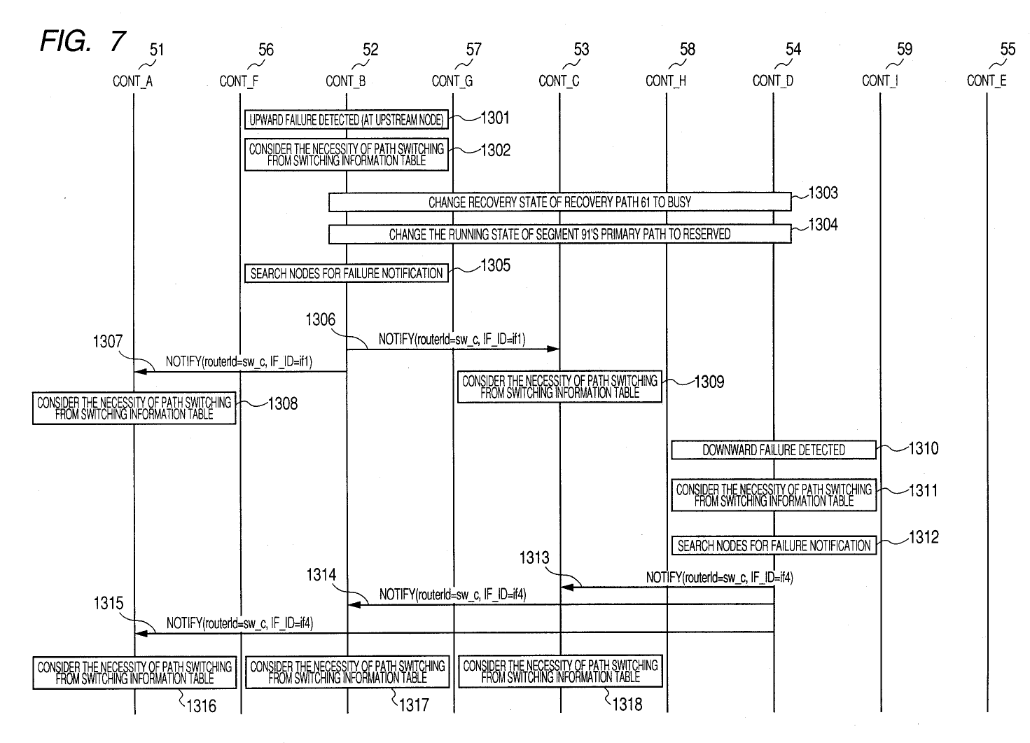

Next, a description will be made for how the network unit 53 makes path switching upon detection of a node failure with reference to FIG. 7.

At first, the failure detection unit 415 (FIG. 8) of the network unit 52 detects a failure in the interface 53A just after node failure occurrence in the network unit 53 (1301). The switching unit 412 (FIG. 8) of the network unit 54 then refers to the rerouting table 500 (FIG. 12D) and decides the necessity of switching to the recovery path 62 (1302). The details of how to make such a decision for the necessity of switching to a recovery path will be described later with reference to FIGS. 24 and 25. The switching unit 412 then sets “busy” for the recovery state of the recovery path 62 (1303) and “reserved” for the running state of the primary path of the segment 83 in the segment management table 800 (1304).

Then the failure notification address accumulator 408 (FIG. 8) of the network unit 52 refers to the failure notification address table 900 (1305). As a result, the control message sender 416 (FIG. 8) of the network unit 52 sends a NOTIFY message to the network units 51 and 52 respectively (1306 and 1307).

The control unit 51E (CONT_A) of the network unit 51, upon receiving the NOTIFY message 1307, refers to the rerouting table 500 (FIG. 12A) and decides that there is no need to make switching to a recovery path (1308). The details of how to make such a decision for the necessity of switching to a recovery path will be described later with reference to FIGS. 24 and 25. The control unit 53E (CONT_C) of the network unit 53, upon receiving the NOTIFY message 1306, refers to the rerouting table 500 (FIG. 12C) and decides that there is no need to make switching to a recovery path (1309). The details of how to make such a decision for the necessity of switching to a recovery path will be described later with reference to FIGS. 24 and 25.

The failure detection unit 415 (FIG. 8) of the network unit 54 detects a failure in the interface 53D just after node failure occurrence in the network unit 53 (1310). The details of how to make such a decision for the necessity of switching to a recovery path will be described later with reference to FIGS. 24 and 25. The switching unit 412 (FIG. 8) of the network unit 53 then refers to the rerouting table 500 (FIG. 12C) and decides that there is no need to make switching to a recovery path (1311). The failure notification address accumulator 408 (FIG. 8) of the network unit 54 then refers to the failure notification address table 900 (FIG. 16) (1312). As a result, the control message transmitter 416 (FIG. 8) of the network unit 54 sends a NOTIFY message to the network units 53, 52, and 51 respectively (1313, 1314, and 1315).

Receiving the NOTIFY message 1315, the control unit 51E (CONT_A) of the network unit 51 refers to the rerouting table 500 (FIG. 12A) and decides that there is no need to make switching to a recovery path (1316). The control unit 52E (CONT_B) of the network unit 52, receiving the NOTIFY message 1314, refers to the rerouting table 500 (FIG. 12B) and decides that there is no need to make switching to a recovery path (1317). Also, the control unit 52E (CON_B) of the network unit 53, receiving the NOTIFY message 1313, refers to the rerouting table 500 (FIG. 12B) and decides that there is no need to make switching to a recovery path (1318). The details of how to make such a decision for the necessity of switching to a recovery path will be described later with reference to FIGS. 24 and 25.

As described above, switching to the recovery path 62 also makes it possible to recover a path failure, even node failures to occur in the network unit 53.

Next, a configuration of the control unit 53E will be described with reference to a block diagram shown in FIG. 8.

The control unit 53E includes a processor and a memory. The processor executes a program stored in the memory to realize each function of the control unit 53E.

Concretely, the control unit 53E consists of a control message receiver 401, a path establishment requesting unit 402, a PATH message processor 403, a RESV message processor 404, a NOTIFY message processor 405, a session information accumulator 406, an interface information accumulator 407, a failure notification address accumulator 408, a segment management information accumulator 409, a cross-connect state accumulator 410, a recovery segment management unit 411, a switching unit 412, a rerouting information accumulator 413, a cross-connect operating unit 414, a failure detection unit 415, a control message sender 416, and a failure status accumulator 417 and executes programs for controlling those units and devices respectively.

The rerouting information accumulator 413 manages the rerouting table 500 (FIG. 12C). The cross-connect state accumulator 410 manages the cross-connect information table 600 (FIG. 13C). The session information accumulator 406 manages the session information table 700 (FIG. 14C). The segment management information accumulator 409 manages the segment management table 800 (FIG. 15). The failure notification address accumulator 408 manages the failure notification address table 900 (FIG. 16). The failure status accumulator 417 manages the failure status table 1000 (FIG. 17). Also, the details of each of those tables will be described later.

The control message receiver 401, upon receiving a GMPLS generalized RSVP-TE message from any of the remote network units 51 to 59, decides the message type. Concretely, if the received message is a PATH message, the control message receiver 401 transfers the PATH message to the PATH message processor 403. Similarly, if the received message is a RESV message, the control message receiver 401 transfers the RESV message to the RESV message processor 404. Also, if the received message is a NOTIFY message, the control message receiver 401 transfer the NOTIFY message to the NOTIFY message processor 405.

The path establishment requesting unit 402, upon receiving a bus establishment request from a remote application, transfers the request to the PATH message processor 403. The PATH message processor 403 then extracts information of both interface and label from the interface information accumulator 407 according to the content of the received request. Then, the PATH message processor 403 creates a PATH message having the self-node as the starting node and including the extracted information of both interface and label and sends the message to the control message sender 416.

The session information accumulator 406 receives a session ID for identifying a target communication path from the PATH message processor 403 and from the RESV message processor 404 respectively. Then, the RESV message processor 404 updates the session information table 700 as needed. Concretely, if the received session ID is not registered in the session information table 700 or if the information in the session information table 700 is required to be updated, the RESV message processor 404 registers the received information in the session information table 700.

The failure notification address accumulator 408, upon receiving a failure notification address from the PATH message processor 403, registers the address in the failure notification address table 900.

The NOTIFY message processor 405 extracts failure location information from the received NOTIFY message and sends the extracted information to the switching unit 412. The switching unit 412 then transfers the received failure location information to the failure status accumulator 417. Also, the failure status accumulator 417 registers the received failure location information in the failure status table 1000.

The failure detection unit 415, upon receiving failure information from any of the failure detection units 320 to 327, transfers the received information to the switching unit 412. The switching unit 412 then transfers the received information to the failure status accumulator 417. The failure status accumulator 417 registers the received failure information in the failure status table 1000.

The switching unit 412 then sends the failure status to the NOTIFY message processor 405. The NOTIFY message processor 405 then generates a NOTIFY message according to the received failure status and sends the generated NOTIFY message to the control message sender 416.

The switching unit 412 extracts failure status information from the failure status table 1000 and sends the extracted information to the failure notification address accumulator 408. The failure notification address accumulator 408 then searches a segment in which the communication path is to be switched according to the failure status information and sends the result to the switching unit 412.

The cross-connect state accumulator 410 receives cross-connect information from the PATH message processor 403 and from the RESV message processor 404 respectively and updates the cross-connect information table 600 with the received cross-connect information. Concretely, if the received cross-connect information is not registered in the cross-connect table 600, the cross-connect state accumulator 410 registers the received information in the table 600.

The segment management information accumulator 409 updates the segment management information table 800. Concretely, the segment management information accumulator 409, upon receiving information of the primary path of a segment that includes the self-node and information of a recovery path from the PATH message processor 403 and from the RESV message processor 404 respectively, registers the received primary path information and the recovery path information in the segment management table 800 respectively.

Receiving the PATH message from the control message receiver 401, the PATH message processor 403 registers the received PATH message in the session information table 700 of the session information accumulator 406. The PATH message processor 403, upon receiving a PATH message from any of remote network units 51 to 59, extracts information of both necessary interface and label from the interface information accumulator 407 to generate a PATH message according to those information items, then sends the generated PATH message to the control message sender 416.

The RESV message processor 404, upon receiving a RESV message from the control message receiver 401, extracts necessary interface and label information items from the interface information accumulator 407 to generate a RESV message according to the extracted information and sends the generated RESV message to the control message sender 416.

Receiving a message from the PATH message processor 403, the RESV message processor 404 or the NOTIFY message processor 405, the control message sender transfers the received message to the remote network units 51 to 59 respectively.

Then, the recovery segment management unit 411 sends a recovery path establishment request to the PATH message processor 403. The recovery segment management unit 411, upon receiving a message denoting that a recovery path is established from the PATH message processor 403 and from the RESV message processor 404 respectively, sends information of the recovery path, as well as information of a primary path section to be protected by the recovery path to the segment management information accumulator 409 respectively. The segment management information accumulator 409, upon receiving those information items, registers those received information items in the segment management information table 800.

Furthermore, the recovery segment management unit 411 creates a recovery path establishment request to be included in a PATH message, then sends the PATH message to the control message sender 416. The recovery segment management unit 411 also sends the decided segment information to the segment management information accumulator 409. The segment management information accumulator 409 then registers the received segment information in the segment management information table 800.

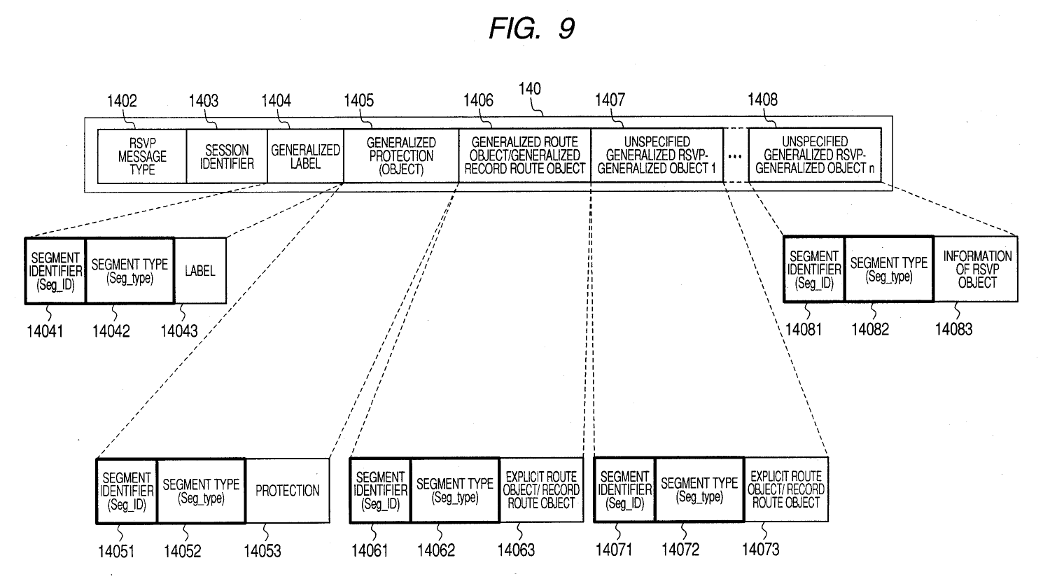

Next, a description will be made for a format of GMPLS generalized RSVP-TE messages of the present invention with reference to FIG. 9.

The GMPLS generalized RSVP-TE message 140 includes fields of RSVP message type 1402, session ID 1403, generalized label 1404, generalized protection 1405, generalized explicit route object/generalized record route object 1406, and other generalized objects 1407 to 1408.

The generalized label 1404 includes fields of segment ID 14041, segment type 14042, and label information 14043. The generalized protection 1405 includes fields of segment ID 14051, segment type 14052, and protection information 14053.

The generalized explicit route object/generalized record route object 1406 includes fields of segment ID 14061, segment type 14062, and record route object 14063. The generalized object 1407 includes fields of segment ID 14071, segment type 14072, and object information 14073. The segment ID 1408 includes fields of segment ID 14081, segment type 14082, and object information 14083.

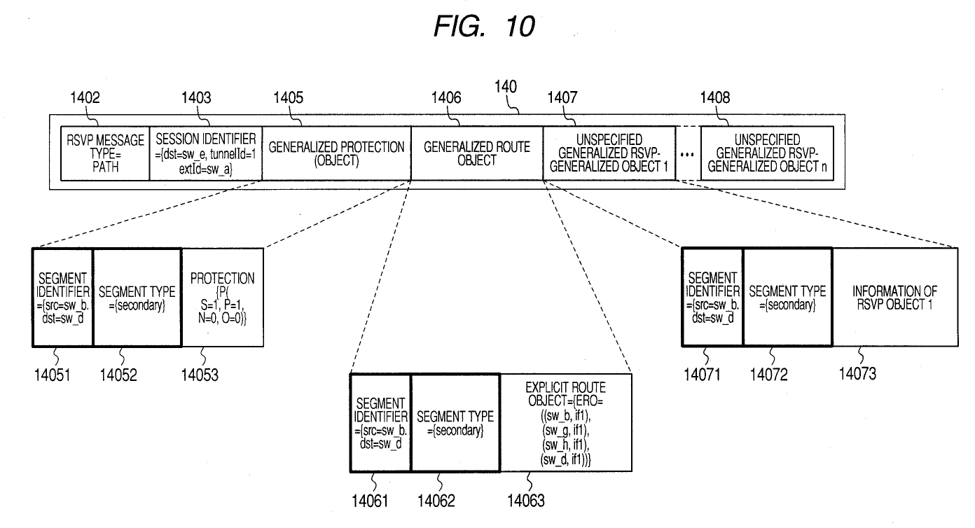

Next, a description will be made concretely for a format of PATH messages sent from the network unit 52 to the network unit 53 with reference to FIG. 10.

Because the GMPLS generalized RSVP-TE message 140 is a PATH message, “PATH” is stored in the RSVP message type field 1402. Also, {src=sw_b, dst=sw_d} is stored in the segment ID of each of the generalized objects 1405, 1406, and 1407. Also, “primary” or “secondary” is stored in the segment type field of each of them.

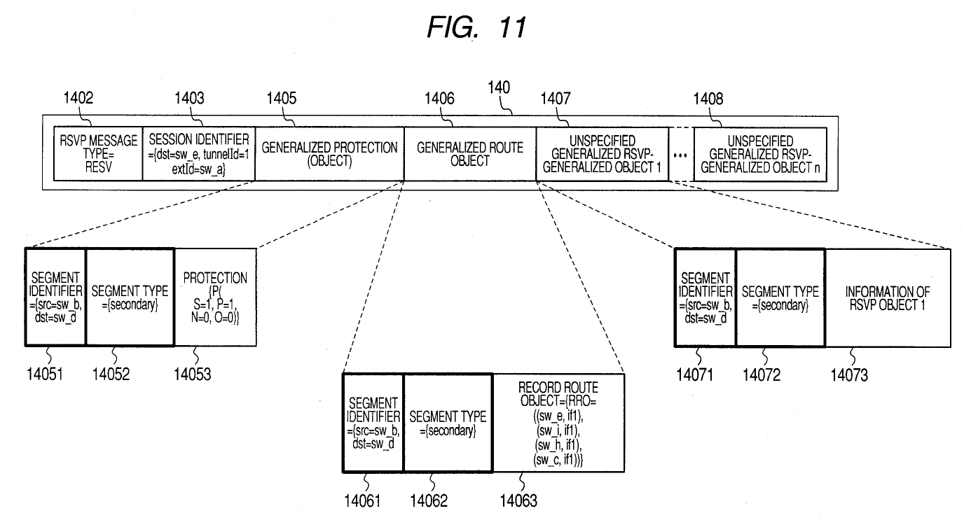

Next, a format of the RESV messages will be described concretely with reference to FIG. 11. The RESV message is sent from the network unit 53 to the network unit 52.

The GMPLS generalized RSVP-TE message 140 is a RESV message. Thus “RESV” is stored in the RESV message type field 1402. Also, {src=sw_b, dst=sw_d} is stored in the segment ID field of each of the generalized objects 1405, 1406, and 1407. Also, “primary” or “secondary” is stored in the segment type field of each of them.

The cross-connect state accumulator 410 of each of the network units 51 to 55 holds a rerouting information table 500 (FIGS. 12A to 12D). Hereunder, a configuration of the rerouting information table 500 will be described with reference to FIG. 12A.

The rerouting information table 500 includes fields of session ID 501, rerouting condition 502, and recovery segment information 503. The recovery segment information 503 includes fields of segment ID information 5031, segment's primary path route 5032, segment type 5033, and recovery path route 5034.

The cross-connect state accumulator 410 of each of the network units 51 to 55 holds a cross-connect information table 600 (FIGS. 13A to 13E). Hereunder, a configuration of the cross-connect information table 600 will be described with reference to FIG. 13A.

The cross-connect information table 600 includes fields of session ID 601, running state 602, data input interface information 603, and data output interface information 604. The data input interface information 603 includes fields of input interface ID 6031 and input label value 6032. The data output interface information 604 includes fields of output interface ID 6041 and output label value 6042.

The session information accumulator 406 of each of the network units 51 to 55 holds a session information table 700 (FIGS. 14A through 14E). Hereunder, a configuration of the session information table 700 will be described with reference to FIG. 14A.

The session information table 700 includes fields of session ID 701, starting node 702, ending node 703, and routing information 704. The routing information 704 includes ERO information 7041 and RRO information 7042. The ERO information 7041 is an explicit route object and the RRO information is a record route object.

The segment management information accumulator 409 of each of the network units 51 to 55 holds a segment management information table 800 (FIG. 15). A configuration of the segment management information table 800 will be described below with reference to FIG. 15.

The segment management information table 800 includes fields of session ID 801, segment ID 802, primary path 803, and recovery path 804. The primary path 803 includes fields of segment type 8031, routing information 8032, and running state 8033. The recovery path information 804 includes fields of segment type 8041, path route 8042, and recovery state 8043.

The failure notification address accumulator 408 of each of the network units 51 to 55 holds a failure notification address table 900 (FIG. 16). The failure notification address table 900 is configured as shown in FIG. 16. The failure notification address table 900 includes fields of session ID 901 and router ID 902.

The failure status accumulator 417 of each of the network units 51 to 55 holds a failure status table 1000 (FIG. 17). The failure status table 1000 is configured as shown in FIG. 17. The failure status table 1000 includes fields of session ID 1001, router ID 1002, interface ID detecting failure 1003, direction 1004, and failure status 1005.

Control information in this first embodiment is exchanged among network units when a new object is added to each of PATH and RESV messages in a refreshing sequence after a basic path of the GMPLS generalized RSVP-TE is established. A PATH message is issued from a sender to a receiver as a message of requesting assignment of a communication path. A RESV message notifies the sending side of the establishment of communication path set in the PATH message.

Next, PATH message receiving processings will be described with reference to FIG. 18. It is assumed here that a PATH message is received by the recovery segment management unit 411.

At first, the recovery segment management unit 411 checks if the received PATH message is a primary path message according to the protection object (P=0) of the message (1701). If the received PATH message is not a primary path message, the recovery segment management unit 411 exits the processing. If the received PATH message is a primary message, the recovery segment management unit 411 executes the following processings for each of the segment IDs set in the PATH message and in the segment management information table 800 (1702).

In other words, the recovery segment management unit 411 searches a record having the session ID 1403, segment ID 14051, and segment type 14052 set in the PATH message and matching with the session ID 801, segment ID 802, and segment type 8031 set in the segment management information table 800 (17021). Then, the recovery segment management unit 411 checks the result of the searching (17022).

If the record is found, the recovery segment management unit 411 compares the contents of the searched record with the segment information in the PATH message. If both do not match, the recovery segment management unit 411 updates the contents of the searched record with the segment information set in the PATH message (17023). If the record is not found, the recovery segment management unit 411 adds a record that stores the items of session ID 1403, segment ID 14061, and routing information 14063 to the session ID field 801, the segment ID field 802, and the segment type field 8031 respectively, then initializes each of those field values (17024).

Next, how to register a failure condition for rerouting in the rerouting table 500 will be described with reference to FIG. 19.

Concretely, the recovery segment management unit 411 executes the following registration processings for the rerouting table 500 upon finding a target record in the searching described above; a processing for register failures detected in a self-node control segment and in a downward segment as conditions (1901), a processing for registering failures detected in a self-node control segment and in an upward segment as conditions (1902), and a processing for registering a failure in a self-node control segment as a condition (1903). In this first embodiment, up to two failure locations are set as rerouting conditions, but the number of failures assumed as rerouting conditions can be set freely.

Hereunder, how to decide the necessity of rerouting will be described.

At first, it is assumed here that there is one link failure location detected in the subject communication path or there are a plurality of link failure locations detected adjacently. In such a case, it is checked whether or not it is possible to bypass all those failure locations if the self-node switches the route to another.

If it is impossible to bypass some of the failure locations when the self-node switches the route to another, the current route is kept as is. At this time, however, if the self-node has already switched the route, the recovery segment management unit 411 switches back to the original route.

On the other hand, if it is possible to bypass all the detected failure locations when the self-node switches the current route to another, the recovery segment management unit 411 checks the switching state of a segment in the downstream of the subject link to be bypassed by rerouting by the self-node. Also, if any of the segments further in the downstream is already switched or being switched, the self-node does not switch the routing for the current communication path to another. If none of the segments further in the downstream is switched nor being switched, the self-node changes the routing for the current communication path to another.

Each of the network units 51 to 59 uses the following methods to check the switching state of a segment in the downstream in the above case. The first method is to indirectly check the switching state of a segment other than the target one to be switched by the self-node according to a failure event while common operation rules are assumed among nodes. The second method is to directly check the switching state of the segment other than the target one to be switched by the self-node by exchanging switching events among nodes.

If there are a plurality of link failure locations detected in a communication path and those failures are separated far from each another, an upstream segment nearest to the first failure location nearest to the starting point is assumed as the first recovery segment. If there is a second failure location other than the first recovery segment, an upstream segment nearest to the second failure location is assumed as the second recovery segment.

If communications are disabled due to the path switching in the first and second recovery segments, the recovery segment management unit 411 decides other segments as the first and second recovery segments. Concretely, the first recovery segment is changed to its nearest upstream segment. If there is a second failure location other than the first recovery segment, an upstream segment nearest to the second failure location is assumed as the second recovery segment. If the communications are disabled due to the path switching in the first and second recovery segments again, the recovery segment management unit 411 changes the first and second recovery segments again. This is repeated until a combination of the first and second recovery segments that can keep the communications is found.

According to the method that decides the necessity of path switching as described above, the recovery segment management unit 411 checks the switching state of another segment in the downstream and if the segment is already switched or being switched, the recovery segment management unit 411 does not switch the communication path. If the segment is not switched nor being switched, the self-node switches the communication path to another. There is also another method to be described below. According to the method, the self-node checks the switching state of another segment in the upstream and if the segment is already switched or being switched, the self-node does not switch the communication path. If the segment is not switched nor being switched, the self-node switches the communication path to another.

Furthermore, if there are a plurality of link failures detected in a communication path and those failures are separated far from each another, a downstream segment farthest from the starting point and nearest to the first failure location is assumed as the first recovery segment. If there is a second failure location other than the first recover segment, a downstream segment nearest to the second failure location is assumed as the second recovery segment.

If communications are disabled due to the path switching in the first and second recovery segments, the recovery segment management unit 411 decides other segments as the first and second recovery segments. Concretely, the first recovery segment is changed to its nearest downstream segment. If there is a second failure location other than the first recovery segment, a downstream segment nearest to the second failure location is assumed as the second recovery segment. If the communications are disabled again due to the path switching in the first and second recovery segments, the recovery segment management unit 411 changes the first and second recovery segments again. This is repeated until a combination of the first and second recovery segments that can keep the communications is found.

Next, a description will be made for a registration processing 1901 to be executed by the recovery segment management unit 411 on conditions that are failures in the self-node control segment and in a downstream segment.

At first, the recovery segment management unit 411 searches the record of the self-node control segment in the segment management table 800 (1914) on the searching condition that is “session ID==RESV message ID && segment ID src==self-node router ID”.

The recovery segment management unit 411 then checks the result of the searching (1915). If there is no record that satisfies the searching conditions, the recovery segment management unit 411 exits the processing in step 1901. If the record is found, the recovery segment management unit 411 extracts the record of a non-overlapped downstream segment nearest to the self-node from the segment management table 800 (1916).

Then, the recovery segment management unit 411 checks the result of the extraction (1917). If the record is not extracted, the recovery segment management unit 411 exits the processing in 1901. If the record is extracted, the recovery segment management unit 411 extracts the record of a downstream segment nearest to the self-node from the segment management table 800 (1918).

Then, the recovery segment management unit 411 checks the result of the extraction (1919). If the record is not extracted, the recovery segment management unit 411 exits the processing in step 1901. If the record is extracted, the recovery segment management unit 411 registers all possible combinations of J1) and J2) as path switching conditions in the rerouting table 500 (1920).

J1) Router ID(s) on a link existing on the primary path of the self-node control segment and not existing on the primary path of the nearest downstream segment, as well as its/their sending directions J2) Router ID(s) on a link existing on the primary path in the downstream of the starting point of the nearest non-overlapped downstream segment, as well as its/their sending directions

After that, the recovery segment management unit 411 extracts a segment in the downstream of the starting point of the non-overlapped downstream segment (1922). Also, the recovery segment management unit 411 checks the result of the extraction (1923). If the segment is not extracted, the recovery segment management unit 411 exits the processing in step 1901. If the segment is extracted, the recovery segment management unit 411 repeats the following processings according to the extracted record until the next nearest downstream segment record cannot be extracted (1921).

At first, the recovery segment management unit 411 extracts a downstream segment nearest to the starting node of the above extracted segment from the segment management table 800 (19211). Then, the recovery segment management unit 411 checks if the starting node of the extracted segment is on the primary path of the self-node control segment (19212). If not on the primary path, the recovery segment management unit 411 exits the processing in step 1921. If it is on the primary segment, the recovery segment management unit 411 registers all possible combinations of K1) and K2) as path switching conditions in the rerouting table 500 (19213).

K1) Router ID(s) on a link existing on the primary path of the previously extracted segment and not existing on the primary path of the currently extracted segment, as well as its/their sending directions K2) Router ID(s) on a link existing on the primary path of a non-overlapped downstream segment and not on the primary path of the previously extracted segment, as well as its/their sending directions As described above, the processing in step 1901 adds records 50505 to 5052 shown in FIG. 12A to the rerouting table 500 of the network unit 51.

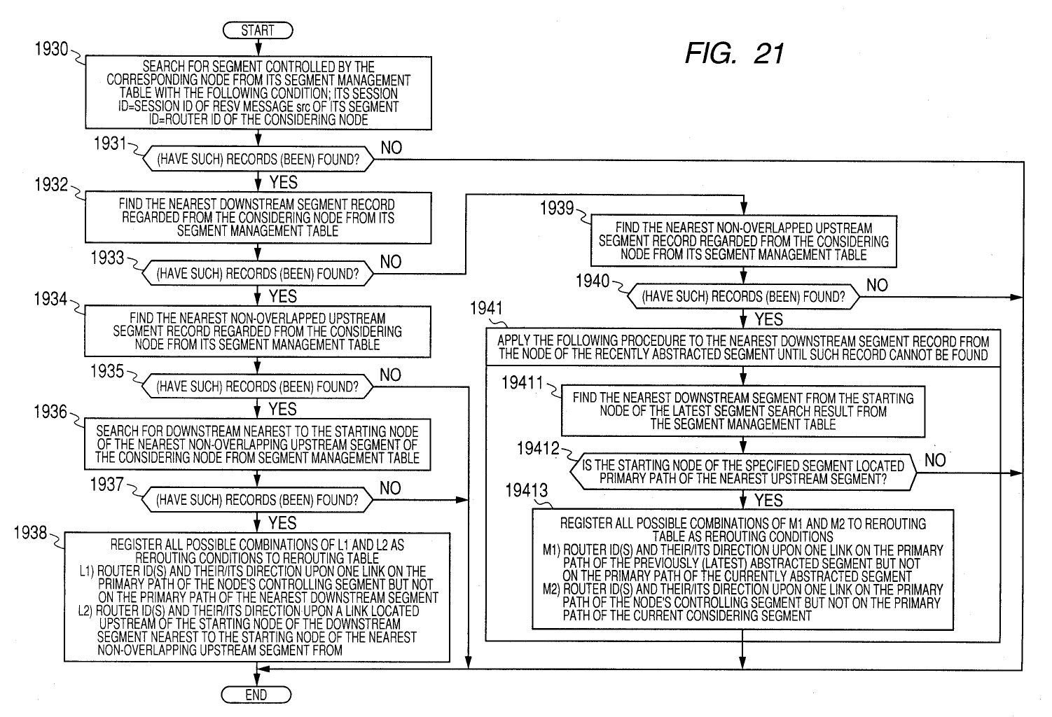

Next, a description will be made for a registration processing 1902 to be executed by the recovery segment management unit 411 on the conditions that are failures detected in the self-node control segment and in an upstream segment with reference to FIG. 21.

At first, the recovery segment management unit 411 searches the record of the self-node management segment in the segment management table 800 (1930) according to the condition that is “session ID==RESV message ID && segment ID src==self-node router ID”.

Then, the recovery segment management unit 411 checks the result of the searching (1931). If the record is not found, the recovery segment management unit 411 exits the processing in step 1902. If the record is found, the recovery segment management unit 411 extracts the record of a downstream segment nearest to the self-node from the segment management table 800 (1932).

Then, the recovery segment management unit 411 checks the result of the extraction (1933). If the record is extracted, the recovery segment management unit 411 goes to step 1934. If not, the recovery segment management unit 411 goes to step 1939.

In step 1934, the recovery segment management unit 411 extracts the record of a non-overlapped upstream segment nearest to the self-node from the segment management table 800 (1934). Then, the recovery segment management unit 411 checks the result of the extraction (1935). If the record is not extracted, the recovery segment management unit 411 exits the processing in step 1902. If the record is extracted, the recovery segment management unit 411 extracts the record of a downstream segment nearest to the starting node of the nearest non-overlapped upstream segment from the segment management table 800 (1936).

Then, the recovery segment management unit 411 checks the result of the extraction (1937). If the record is not extracted, the recovery segment management unit 411 exits the processing in step 1902. If the record is extracted, the recovery segment management unit 411 registers all possible combinations of L1) and L2) as path switching conditions in the rerouting table 500 (1938).

L1) Router ID(s) on a link existing on the primary path of the self-node control segment and not on the primary path of the nearest downstream segment, as well as its/their sending directions L2) Router ID(s) on a link existing on the primary path in the downstream of the starting point of a downstream segment nearest to the starting node of the nearest non-overlapped upstream segment, as well as its/their sending directions

Also, if the record is not extracted in step 1933, the recovery segment management unit 411 extracts the record of a non-overlapped upstream segment nearest to the self-node from the segment management table 800 (1939). Then, the recovery segment management unit 411 checks the result of the extraction (1940). If the record is not extracted, the recovery segment management unit 411 exits the processing in step 1902. If the record is extracted, the recovery segment management unit 411 repeats the following processings until the next nearest downstream segment record cannot be extracted (1941).

At first, the recovery segment management unit 411 extracts a downstream segment nearest to the starting node of the previously extracted segment from the segment management table 800 (19411). Then, the recovery segment management unit 411 checks if the starting node of the extracted segment is on the primary path of the nearest non-overlapped upstream segment (19412). If not on the primary path, the recovery segment management unit 411 exits the processing in step 1902. If it is on the primary segment, the recovery segment management unit 411 registers all possible combinations of M1) and M2) as rerouting conditions in the rerouting table 500 (19413).

M1) Router ID(s) on a link existing on the primary path of the previously extracted segment and not existing on the primary path of the currently extracted segment, as well as its/their sending directions M2) Router ID(s) on a link existing on the primary path of the self-node control segment and not on the primary path of the currently extracted segment, as well as its/their sending directions

As described above, the processing in step 1902 adds records 5071 to 5073 shown in FIG. 12C to the rerouting table 500 of the network unit 53.

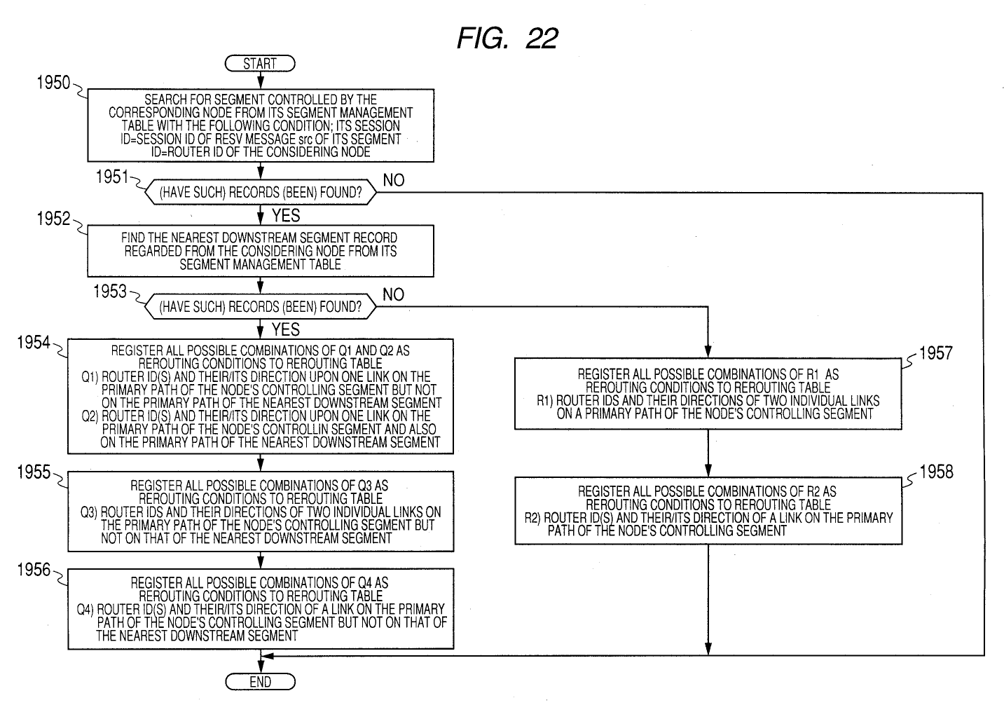

Next, a description will be made for a registration processing 1903 to be executed by the recovery segment management unit 411 on the condition that is a failure detected in the self-node control segment with reference to FIG. 22.

At first, the recovery segment management unit 411 searches the record of the self-node management segment in the segment management table 800 (1950) on the searching condition that is “session ID==RESV message ID && segment ID src==self-node router ID”.

The recovery segment management unit 411 then checks the result of the searching (1951). If the record is not found, the recovery segment management unit 411 exits the processing in step 1912. If the record is found, the recovery segment management unit 411 extracts the record of a downstream segment nearest to the self-node from the segment management table 800 (1952).

Then, the recovery segment management unit 411 checks the result of the extraction (1953). If the record is extracted, the recovery segment management unit 411 goes to step 1954. If not, the recovery segment management unit 411 goes to step 1957.

In step 1957, the recovery segment management unit 411 registers all possible combinations of R1) as path switching conditions in the rerouting table 500.

R1) Router ID(s) on two links existing on the primary path of the self-node management, as well as its/their sending directions

Furthermore, the recovery segment management unit 411 registers all possible combinations of R2) as path switching conditions in the rerouting table 500 (1958).

R2) Router ID(s) on a link existing on the primary path of the self-node control segment, as well as its/their sending directions

If the record is extracted in step 1953, the recovery segment management unit 411 registers all possible combinations of Q1) and Q2) as path switching conditions in the rerouting table 500 (1954).

Q1) Router ID(s) on a link existing on the primary path of the self-node control segment and not existing on the primary path of the nearest downstream segment, as well as its/their sending directions Q2) Router ID(s) on a link existing on the primary path of the self-node control segment and not existing on the primary path of the nearest downstream segment, as well as its/their sending directions

Furthermore, the recovery segment management unit 411 registers all possible combinations of Q3) as path switching conditions in the rerouting table 500 (1955).

Q3) Router ID(s) on two links existing on the primary path of the self-node control segment and not existing on the primary path of the nearest downstream segment, as well as its/their sending directions

Furthermore, the recovery segment management unit 411 registers all possible combinations of Q4) as path switching conditions in the rerouting table 500 (1956).

Q4) Router ID(s) on a link existing on the primary path of the self-node control segment and not existing on the primary path of the nearest downstream segment, as well as its/their sending directions

As described above, the processing in step 1903 adds records 5053 to 5055 shown in FIG. 12A, records 5064 to 5066 shown in FIG. 12B, and records 5074 to 5076 shown in FIG. 12C to the rerouting table 500 of the network units 51 to 53 respectively.

Next, a description will be made for a sequence of processings executed by the recovery segment management unit 411 to register a failure notification address to the failure notification address table with reference to FIG. 23.

At first, the recovery segment management unit 411 executes a registration processing (19771) of a router ID in the first item in each of the session information and the routing information of each record in the segment management table 800 (1977).

Next, a description will be made for a switching processing to be executed by the switching unit 412 upon receiving a NOTIFY message from the NOTIFY message processor 405 with reference to FIG. 24.

At first, the switching unit 412 searches a record having the router ID, interface information, and session information set in the failure information received from the NOTIFY message processor 405 in the failure status table 1000 (2101). Then, the switching unit 412 checks the result of the searching (2102).

If not found, the switching unit 412 registers the router ID and the interface set in the failure information received from the NOTIFY message processor 405 in the router ID field 1002 and in the interface ID detecting failure field 1003 in the failure status table 1000 (2103) respectively. If found, the switching unit 412 searches a record having the session information received from the failure detection unit in the failure status table 1000 (2105). Then, the switching unit 412 checks the result of the searching (2106).

If the record is not found, the switching unit 412 exits the processing. If the record is found, the switching unit 412 then searches a record having the router ID and the interface ID of the found record in the rerouting table 500 (2107). Then, the switching unit 412 checks the result of the searching (2108).

If the record is not found, the switching unit 412 exits the processing. If the record is found, the switching unit 412 requests the recovery segment management unit 411 for switching to a route specified in the recovery routing information of the record's recovery segment (2109). After that, the switching unit 412 searches the session information and a record in which the self-node matches with the first item of the routing information set in the recovery information in the segment management table 800 (2110). Then, the switching unit 412 checks the result of the searching (2111).

If the record is not found, the switching unit 412 exits the processing. If the record is found, the switching unit 412 decides whether or not the “busy” is set for the recovery state of the recovery path information in the record (2112). If “busy” is set, the switching unit 412 request the recovery segment management unit 411 for switching back to the route specified in the routing information of the primary path information in the record (2113).

Next, a description will be made for a rerouting processing to be executed by the switching unit 412 upon receiving failure notification from the failure detection unit 415 with reference to FIG. 25.

At first, the switching unit 412 searches a record having the router ID, interface information, and session information of the failure location received from the NOTIFY message processor 405 in the failure status table 1000 (2201). Then, the switching unit 412 checks the result of the searching (2202).

If the record is not found, the switching unit 412 registers the router ID and the interface information set in the failure location information received from the NOTIFY message processor 405 in the router ID field 1002 and in the interface ID detecting failure field 1003 of the failure status table 1000 (2203) respectively. If the record is found, the switching unit 412 creates a NOTIFY message for notifying the self-node failure and sends the message to the NOTIFY message processor 405 (2204) so that the message is passed to the address denoted by the router ID set in the failure notification address table. Then, the switching unit 412 searches a record having the session ID received from the failure detection unit 415 in the failure status table 1000 (2205). Then, the switching unit 412 checks the result of the searching (2206).

If the record is not found, the switching unit 412 exits the processing. If the record is found, the switching unit 412 searches a record having the router ID and the interface ID matching with those set in the record list as rerouting conditions (2207). Then, the switching unit 412 checks the result of the searching (2208).

If the record is not found, the switching unit 412 goes to step 2210. If the record is found, the switching unit 412 requests the recovery segment management unit 411 for switching to a route specified in the recovery routing information set in the recovery segment of the found record (2209).

Then, the switching unit 412 searches a record having the information matching with the session ID and the first item set in the routing information of the self-node recovery path information in the segment management table 800 (2210). Then, the switching unit 412 checks the result of the searching (2211).

If the record is not found, the switching unit 412 exits the processing. If the record is found, the switching unit 412 checks if “busy” is set for the recovery state of the recovery path information of the found record (2212). If “busy” is set, the switching unit 412 requests the recovery segment management unit 411 for switching back to the route specified in the routing information set in the primary path information of the found record (2213).

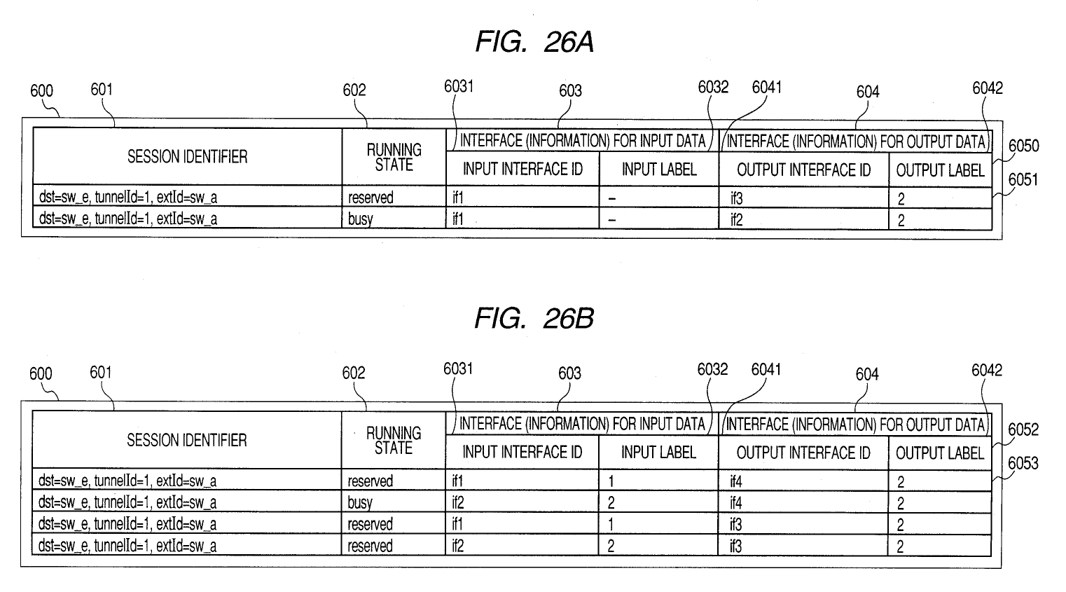

Next, a description will be made for a cross-connect information table 600 of each of the control unit 51E (CONT_A) and the control unit 53E (CONT_C) assumed after path switching caused by failures in the links 31 and 32 or a node failure in the network unit 53 (sw_c) with reference to FIGS. 26A and 26B.

After switching to the recovery path 62, the running state of the record 6050 in the cross-connect information table 600 of the control unit 51E (CONT_A) is changed from “busy” to “reserved”. The running state of the record 6051 in the cross-connect information table 600 of the control unit 51E (CONT_A) is changed from “reserved” to “busy”.

After switching to the recovery path 62, the running state of the record 6052 in the cross-connect information table 600 of the control unit 53E (CONT_A) is changed from “busy” to “reserved”. The running state of the record 6053 in the cross-connect information table 600 of the control unit 53E (CONT_C) is changed from “reserved” to “busy”.

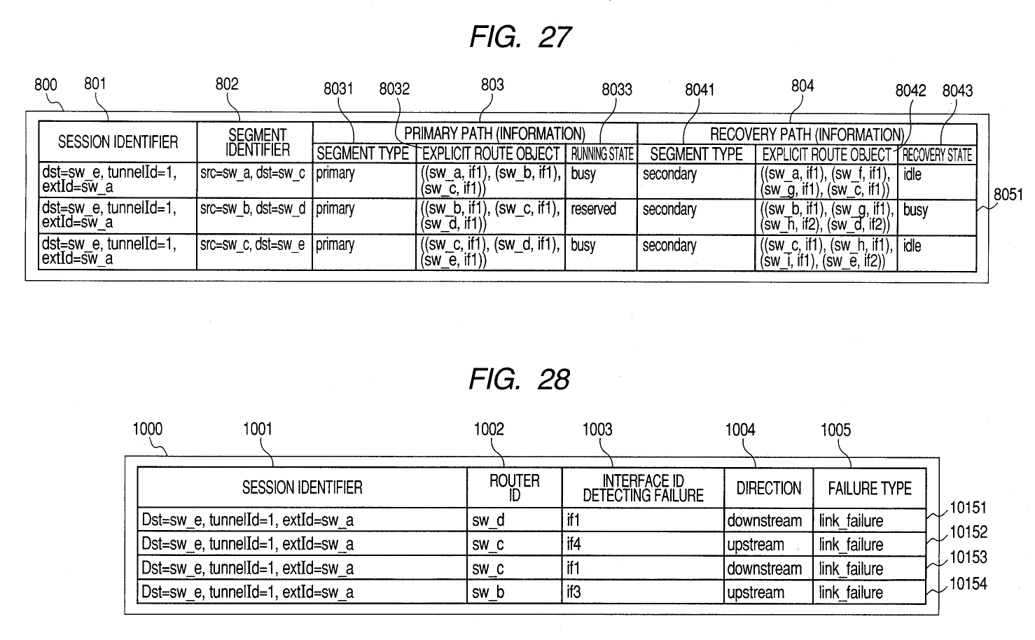

Next, a description will be made for the segment management table 800 in each of the control units 51E (CONT_A) to 53E (CONT_C) after path switching caused by failures in the links 31 and 32 or by a node failure in the network unit 53 (sw_c) with reference to FIG. 27.

After switching to the recovery path 62, the running state of the primary path of the record 8051 in the segment management table 800 of each of the control units 51E (CONT_A) to 55E (CONT_E) is changed to “reserved” and the recovery state of the secondary path is changed to “busy”.

Next, a description will be made for the failure status table 1000 of each of the control units 51E (CONT_A) to 55E (CONT_E) after path switching caused by failures in the links 31 and 32 with reference to FIG. 28.

After occurrence of failures in the links 31 and 32, records 10151 to 10154 are added to the failure status table 1000 of each of the control units 51E (CONT_A) to 55E (CONT_E).

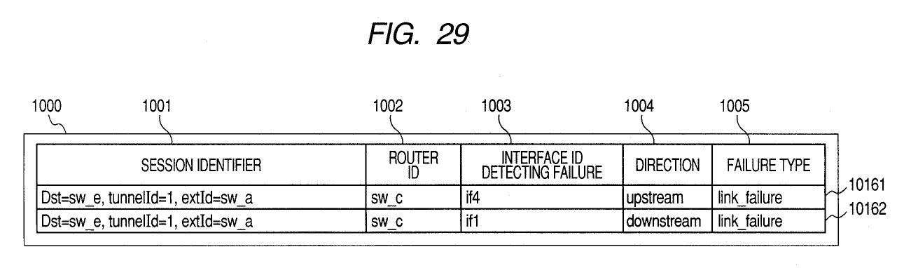

Next, a description will be made for the failure status table 1000 of each of the control units 51E (CONT_A) to 55E (CONT_E) assumed after path switching caused by a node failure in the network unit 53 (sw_c) with reference to FIG. 29.

After occurrence of a node failure in the network unit 53 (sw_c), records 10161 to 10162 are added to the failure status table 1000 of each of the control units 51E (CONT_A) to 55E (CONT_E).

### Second Embodiment

Next, a second embodiment of the present invention will be described.

In the first embodiment described above, the GMPLS generalized RSVP-TE is used as a signaling program. However, the present invention can also use another protocol such as the GMPLS CR-LDP, or the like.

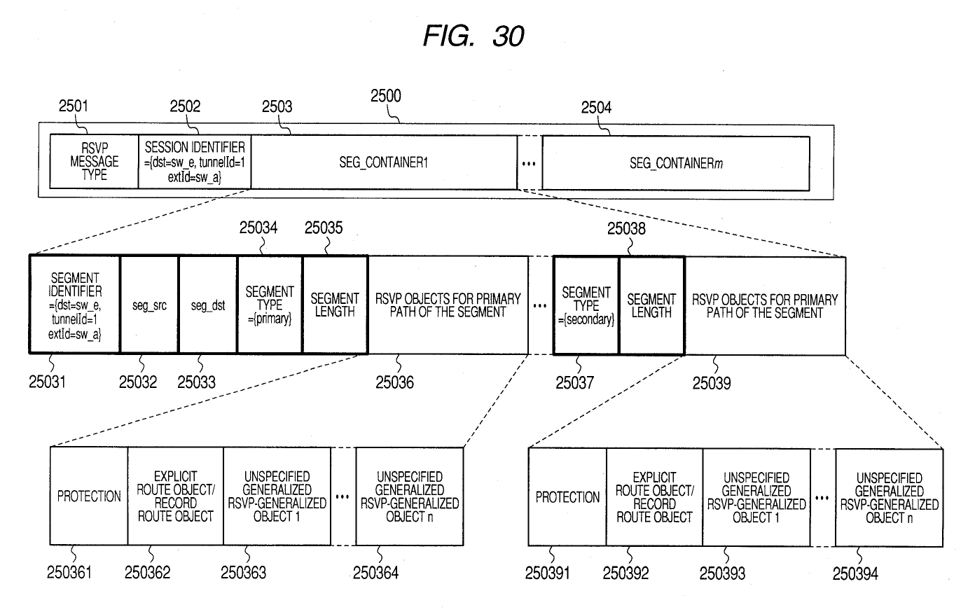

FIG. 30 shows a message format used by a network system in this second embodiment of the present invention.

Just like the network system in the first embodiment, the network system in this second embodiment uses a segment generalized object for each RESV message to enable segment information to be notified among network units.

In FIG. 9 of the first embodiment, each object is defined individually. In FIG. 30 of this second embodiment, each segment is stored in the same container. Each of the containers (2503 to 2504) includes items of segment ID (25031), segment's starting point node information (25032), and segment's ending point node information (25033).

A container includes primary path information items (25034 to (25036) and secondary path information items (25037 to 25039) of a segment. Each of the primary path information items (25034 to 25036) includes fields of segment type (25034), segment length (25035) representing a length of primary path information, and RSVP object (25036) related to a segment primary path. The segment primary path related RSVP object (25036) includes fields of protection information (250361) and explicit route object/record route object (250362).

Similarly, each of the segment's secondary path information items (25037 to 25039) includes fields of segment type (25037), segment length (25038) representing a length of primary path information, and segment primary path related RSVP object (25039). The segment primary path related RSVP object (25039) includes fields of protection information (250391) and explicit route object/record route object (250392).

The present invention can thus apply to a communication network system for controlling connection/disconnection of a communication path with use of a signaling protocol. Particularly, the present invention can apply favorably to a GMPLS network for establishing an LSP with use of a GMPLS generalized RSVP=TE or GMPLS generalized CR-LDP.

What is claimed is:

1. A network unit comprising a processor for executing computing operations and a memory used by said processor, wherein said network unit exchanges a control message with a remote network unit along a communication path to be established in said network;
wherein said network has a bypass set for each segment that includes one or a plurality of links;
wherein said processor, upon detecting a link failure in said communication path, notifies said remote network unit of a failure event denoting said link failure and switching said failure detected link to another communication path;
wherein said processor, upon receiving a failure event from said remote network unit, switches said link related to said received failure event to another communication path, then adds identification information of a switched section of said link to said control message and sends said identification information added control message to said remote network unit;
wherein said network unit decides whether or not it is possible to bypass all failure occurred links detected in said communication path by switching said communication path to another;
wherein said network unit, when it is possible to bypass all of said failure occurred links, detects a switching state of a downstream segment that can bypass all of said failure occurred links,
wherein said network unit does not switch said communication path when said communication path is already switched or being switched; and
wherein said network unit switches to said bypass when said communication path is not switched nor being switched in said downstream segment.

2. The network unit according to claim 1,
wherein said processor switches back to said original communication path when it is not possible to bypass some of said failure links and said communication path is already switched, and does not switch to said bypass when said communication path is not switched nor being switched.

3. The network unit according to claim 1,
wherein said processor, when it is possible to bypass all of said failure occurred links, checks a switching state of an upstream segment that can bypass all of said failure occurred links;
wherein said processor, when said communication path is already switched or being switched, does not switch said communication path; and
wherein said processor, when said communication path is not switched nor being switched in said upstream segment, switches to said bypass.

4. The network unit according to claim 1,
wherein said processor, upon detecting a failure in said link or upon receiving a failure event, detects a segment in which said communication path is switched.

5. The network unit according to claim 1,
wherein said processor, upon switching said communication path to another, notifies said remote network unit of a switching event denoting that said communication path is switched to another;
wherein said processor, upon receiving a switching event from said remote network unit, detects a switching state of a segment related to said received switching event.

6. The network unit according to claim 1,
wherein said control message conforms to a GMPLS generalized RSVP-TE protocol.

7. The network unit according to claim 6,
wherein said control message includes segment information.

8. A network system including at least a first network unit and a second network unit in its network,
wherein said network has a bypass set for each segment including one or a plurality of links;
wherein each of said first and second network units includes a processor for executing a computing operation and a memory used by said processor;
wherein said network unit exchanges a control message with a remote network unit along a communication path to be established in said network;
wherein said network unit, upon detecting a failure in a link included in said communication path, notifies said remote network unit of a failure event denoting said link failure and switches said failure detected link to another communication path;
wherein said network unit, upon receiving said failure event from said remote network unit, switches a link related to said received failure detected link to another communication path and adds identification information of a switched section of said link to said control message, then sends said identification information added control message to said remote network units;
wherein said first network unit decides whether or not it is possible to bypass all of failure links detected in said communication path by switching said communication path to another;
wherein said first network unit detects a switching state of a downstream segment that can bypass all of said failure detected links when it is possible to bypass all of said failure detected links;
wherein said first network unit does not switch said communication path when said communication path is already switched or being switched; and
wherein said network unit switches said communication path to a bypass when said communication path is not switched nor being switched.

9. The network system according to claim 8,
wherein said first network unit switches back to said original communication path when it is not possible to bypass some of said failure links and said communication path is already switched, and does not switch said communication path when said communication path is not switched.

10. The network system according to claim 8,
wherein said first network unit, when it is possible to bypass all of said failure links, checks a switching state of an upstream segment that can bypass all of said failure links;
wherein said first network unit, when said communication route is already switched or being switched over, does not switch said communication path; and
wherein said network unit, when said communication path is not switched nor being switched in said upstream segment, switches said communication path to a bypass.

11. The network system according to claim 8,
wherein said processor of said first network unit, upon detecting said failure link or upon receiving an failure event, detects a segment in which said communication path is switched.

12. The network system according to claim 8,
wherein said first network unit, when switching said communication path to another, notifies said remote network unit of a switching event denoting that said communication path is switched; and
wherein said first network unit, upon receiving a switching event from said remote network unit, detects a switching status of a segment related to said switching event.

13. The network system according to claim 8,
wherein each of said first and second network units sends/receives control messages conforming to said GMPLS generalized RSVP-TE protocol.

14. The network system according to claim 13,
wherein each of said first and second network unit sends/receives control messages, each including each segment information.
